(19) United States
(12) Patent Application Publication
(10) Pub. No.: US 2026/0091589 A1
(43) Pub. Date: Apr. 2, 2026

(54) Liquid Ejecting Head And Liquid Ejecting Apparatus

(71) Applicant: SEIKO EPSON CORPORATION, Tokyo (JP)

(72) Inventor: Fumiya TAKINO, Shiojiri (JP)

(21) Appl. No.: 19/343,178

(22) Filed: Sep. 29, 2025

(30) Foreign Application Priority Data
Sep. 30, 2024 (JP) 2024-170134

(51) Int. Cl. B41J 2/175; B41J 2/165; B41J 2/21; B41J 11/00; B41J 25/34

(52) U.S. Cl. CPC B41J 2/175; B41J 2/16505; B41J 2/2103; B41J 11/0045; B41J 25/34

(57) ABSTRACT

A liquid ejecting head includes: a first nozzle group that ejects liquid; a second nozzle group that ejects liquid; and a plurality of flow path plates stacked in a first direction, the plurality of flow path plates include a supply flow path for supplying liquid to the first nozzle group and the second nozzle group, and the supply flow path includes a first flow path extending in the first direction, a first individual flow path connected to an end portion of the first flow path in the first direction, extending in a direction intersecting the first direction, and individually communicating with the first nozzle group, and a second individual flow path connected to the first flow path at a branch position located at an intermediate position on the first flow path, extending in a direction intersecting the first direction, and individually communicating with the second nozzle group.

The present application is based on, and claims priority from JP Application Serial Number 2024-170134, filed Sep. 30, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

JP-A-2023-009390 discloses a technique related to a liquid ejecting head including a plurality of nozzle groups that eject liquid and supply flow paths that supply liquid to the plurality of nozzle groups. To be specific, in the liquid ejecting head described in JP-A-2023-009390, a supply flow path is disclosed which includes: a first flow path that extends in a first direction from an inlet through which liquid is introduced; a first branch flow path that extends in a first extending direction intersecting the first direction at a branch position which is an end portion of the first flow path in the first direction and that supplies liquid to a first nozzle group of the plurality of nozzle groups; and a second branch flow path that extends in a second extending direction opposite to the first extending direction at the branch position which is the end portion of the first flow path in the first direction and that supplies liquid to a second nozzle group of the plurality of nozzle groups.

However, in the related art, the first branch flow path and the second branch flow path are opposed to each other at the branch position where the first branch flow path and the second branch flow path branch from the first flow path. Therefore, in the related art, for example, when suction cleaning is performed which includes one or both of two suction operations, namely, a first suction operation of sucking liquid from the first branch flow path and the first flow path by sucking the liquid in the supply flow path through the first nozzle group and a second suction operation of sucking liquid from the second branch flow path and the first flow path by sucking the liquid in the supply flow path through the second nozzle group, the negative pressure from one branch flow path acts on the other branch flow path, and the negative pressure acting on the first flow path decreases in some cases. Specifically, in the related art, for example, when the liquid in the supply flow path is sucked through the first nozzle group in the first suction operation, since the negative pressure applied to the first branch flow path acts more strongly on the second branch flow path than on the first flow path, a flow of liquid from the second branch flow path to the first branch flow path occurs, and hence, liquid cannot be efficiently sucked from the first flow path in some cases. Similarly, in the related art, for example, when the liquid in the supply flow path is sucked through the second nozzle group in the second suction operation, since the negative pressure applied to the second branch flow path acts more strongly on the first branch flow path than on the first flow path, a flow of liquid from the first branch flow path to the second branch flow path occurs, and hence, liquid cannot be efficiently sucked from the first flow path in some cases.

### SUMMARY

To solve the above problem, a liquid ejecting head according to the present disclosure includes: a first nozzle group that ejects liquid; a second nozzle group that ejects liquid; and a plurality of flow path plates stacked in a first direction, the plurality of flow path plates include a supply flow path for supplying liquid to the first nozzle group and the second nozzle group, and the supply flow path includes a first flow path extending in the first direction, a first individual flow path connected to an end portion of the first flow path in the first direction, extending in a direction intersecting the first direction, and individually communicating with the first nozzle group, and a second individual flow path connected to the first flow path at a branch position located at an intermediate position on the first flow path, extending in a direction intersecting the first direction, and individually communicating with the second nozzle group.

A liquid ejecting apparatus according to the present disclosure includes: a liquid ejecting head; a cap configured to form a closed space communicating with a plurality of nozzles formed in an ejection surface, between the cap and the ejection surface, when the cap seals the ejection surface of the liquid ejecting head; and a depressurizing mechanism that depressurizes the closed space, the liquid ejecting head includes: a first nozzle group that ejects liquid; a second nozzle group that ejects liquid; and a plurality of flow path plates stacked in a first direction, the plurality of flow path plates include a supply flow path for supplying liquid to the first nozzle group and the second nozzle group, and the supply flow path includes a first flow path extending in the first direction, a first individual flow path connected to an end portion of the first flow path in the first direction, extending in a direction intersecting the first direction, and individually communicating with the first nozzle group, and a second individual flow path connected to the first flow path at a branch position located at an intermediate position on the first flow path, extending in a direction intersecting the first direction, and individually communicating with the second nozzle group.

### BRIEF DESCRIPTION OF THE DRAWINGS

FIG. 1 is a configuration diagram illustrating an example of a liquid ejecting apparatus 100 according to an embodiment of the present disclosure.

FIG. 2 is a plan view illustrating an example of the configuration of a head unit HD.

FIG. 3 is a perspective view illustrating an example of the configuration of a support member 5.

FIG. 4 is a plan view illustrating an example of the configuration of the head unit HD.

FIG. 5 is a cross-sectional view illustrating an example of the configuration of the head unit HD.

FIG. 6 is an exploded perspective view illustrating an example of the configuration of a liquid ejecting head 1.

FIG. 7 is a cross-sectional view illustrating an example of the configuration of the head unit HD.

FIG. 8 is a cross-sectional view illustrating an example of the configuration of the head unit HD.

FIG. 9 is a cross-sectional view illustrating an example of the configuration of the head unit HD.

FIG. 10 is a schematic diagram illustrating an example of the configuration of the head unit HD.

FIG. 11 is a cross-sectional view illustrating an example of the configuration of the head unit HD.

FIG. 12 is a cross-sectional view illustrating an example of the configuration of the head unit HD.

FIG. 13 is a schematic diagram illustrating an example of the configuration of a head unit HD-W1 according to Comparative Example W1.

FIG. 14 is a schematic diagram illustrating an example of the configuration of a head unit HD-W2 according to Comparative Example W2.

FIG. 15 is a schematic diagram illustrating an example of the configuration of a head unit HD-B1 according to Modification B1.

FIG. 16 is a schematic diagram illustrating an example of the configuration of a head unit HD-B2 according to Modification B2.

FIG. 17 is a perspective view illustrating an example of the configuration of a relay substrate 14.

FIG. 18 is a plan view illustrating an example of the configuration of the liquid ejecting head 1.

FIG. 19 is an explanatory diagram illustrating an example of supply flow paths Q(1) to Q(4).

FIG. 20 is a schematic diagram illustrating an example of the configuration of a supply flow path Q.

FIG. 21 is a plan view illustrating an example of the configuration of the supply flow paths Q(1) to Q(4).

FIG. 22 is a schematic diagram illustrating an example of the configuration of a supply flow path Q-V1 according to Comparative Example V1.

FIG. 23 is an explanatory diagram illustrating an example of a suction cleaning process for the supply flow path Q-V1 according to Comparative Example V1.

FIG. 24 is an explanatory diagram illustrating an example of the suction cleaning process for the supply flow path Q.

FIG. 25 is a schematic diagram illustrating an example of the configuration of a supply flow path Q-V2 according to Comparative Example V2.

FIG. 26 is a schematic diagram illustrating an example of the configuration of a supply flow path Q-V3 according to Comparative Example V3.

FIG. 27 is a schematic diagram illustrating an example of the configuration of a supply flow path Q-C1 according to Modification C1.

FIG. 28 is a schematic diagram illustrating an example of the configuration of a supply flow path Q-C2 according to Modification C2.

FIG. 29 is a cross-sectional view illustrating an example of the configuration of the liquid ejecting head 1.

FIG. 30 is a cross-sectional view illustrating an example of the configuration of the liquid ejecting head 1.

FIG. 31 is a perspective view illustrating an example of the configuration of a filter fixing screw 61 and a nut 62 and their vicinity.

FIG. 32 is a plan view illustrating an example of the configuration of the liquid ejecting head 1.

FIG. 33 is a cross-sectional view illustrating an example of the configuration of the liquid ejecting head 1.

FIG. 34 is a cross-sectional view illustrating an example of the configuration of the liquid ejecting head 1.

FIG. 35 is a cross-sectional view illustrating an example of the configuration of the liquid ejecting head 1.

FIG. 36 is a perspective view illustrating an example of the configuration of a lower holder 131.

FIG. 37 is a perspective view illustrating examples of the configurations of a fixing plate 11 and the lower holder 131.

FIG. 38 is a configuration diagram illustrating an example of a liquid ejecting apparatus 100D according to Modification 1 of the present disclosure.

FIG. 39 is a plan view illustrating an example of a head unit HD-D according to Modification 1.

### DESCRIPTION OF EMBODIMENTS

Hereinafter, an embodiment for carrying out the present disclosure will be described with reference to the drawings. Meanwhile, in each drawing, the dimensions and scale of each component are different from the actual dimensions and scale as appropriate. In addition, since the embodiment described below is a suitable specific example of the present disclosure, it includes various technically preferable limitations, but the scope of the present disclosure is not limited to the embodiment unless otherwise stated in the following description to particularly limit the present disclosure.

### A. Embodiment

Hereinafter, a liquid ejecting apparatus 100 according to an embodiment will be described.

### A.1. Overview of Liquid Ejecting Apparatus 100

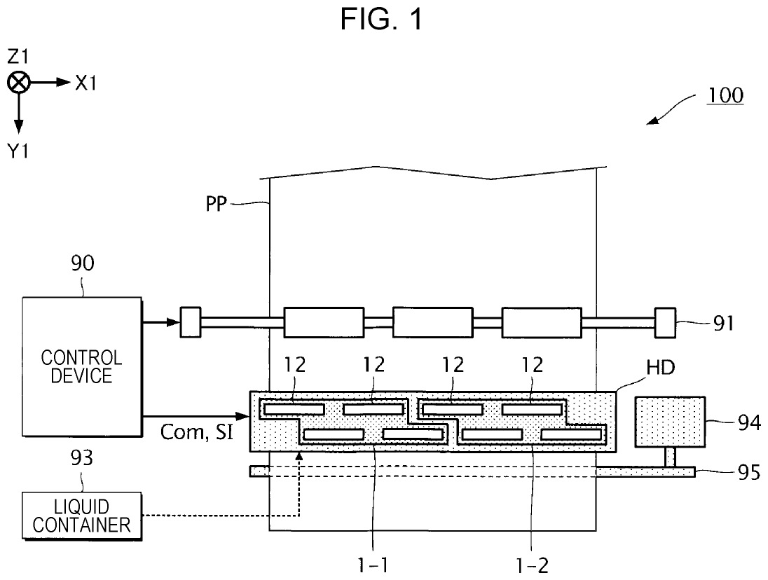

FIG. 1 is an explanatory diagram illustrating the liquid ejecting apparatus 100 according to the present embodiment.

The liquid ejecting apparatus 100 is an ink jet printing apparatus that ejects ink onto a medium PP. The medium PP is typically printing paper, but any printing target such as a resin film or woven fabric may be used as the medium PP.

As illustrated in FIG. 1, the liquid ejecting apparatus 100 includes a head unit HD, a control device 90, a transport mechanism 91, a liquid container 93, a cleaning unit 94, and a movement mechanism 95.

The liquid container 93 stores ink and supplies the stored ink to the head unit HD. As the liquid container 93, for example, a cartridge which can be attached to and detached from the liquid ejecting apparatus 100, a bag-shaped ink pack formed of a flexible film, an ink tank which can be replenished with ink, or the like can be employed. The liquid container 93 stores a plurality of types of ink with different colors.

The ink is an example of “liquid”.

The control device 90 includes, for example, a processing circuit such as a CPU or an FPGA, and a storage circuit such as a semiconductor memory, and controls each element of the liquid ejecting apparatus 100. Here, “CPU” is an abbreviation of “central processing unit”, and “FPGA” is an abbreviation of “field-programmable gate array”.

The control device 90 supplies the head unit HD with a drive signal Com for driving the head unit HD and a control signal SI for controlling the head unit HD. The head unit HD is driven by the drive signal Com under the control of the control signal SI, and ejects ink from some or all of a plurality of nozzles N provided in the head unit HD. The nozzles N will be described later.

The transport mechanism 91 transports the medium PP in the Y1 direction parallel to the Y-axis under the control of the control device 90.

Hereinafter, the Y1 direction and a Y2 direction opposite to the Y1 direction will be collectively referred to as a Y-axis direction. Additionally, hereinafter, an X1 direction along an X-axis that intersects the Y-axis and an X2 direction opposite to the X1 direction will be collectively referred to as an X-axis direction. Further, hereinafter, a Z1 direction along a Z-axis that intersects the X-axis and the Y-axis and a Z2 direction opposite to the Z1 direction will be collectively referred to as a Z-axis direction. In the present embodiment, it is assumed that the ejection direction of ink from the nozzles N is the Z1 direction.

Hereinafter, the Z1 direction may be referred to as the “downward direction”, and the Z2 direction may be referred to as the “upward direction”. In addition, hereinafter, in a case where when viewed from one object, another object is provided in a region positioned in the Z1 direction, it may be expressed that “another object is provided below one object”. Hereinafter, in a case where when viewed from one object, another object is provided in a region positioned in the Z2 direction, it may be expressed that “another object is provided above one object”. In addition, the description in the present embodiment is based on an example in which the X axis, the Y axis, and the Z axis are orthogonal to one another. However, the present disclosure is not limited to such a configuration. The X-axis, the Y-axis, and the Z-axis need only to intersect one another.

The head unit HD is a line head provided with a plurality of nozzles N so as to be able to eject ink in a range wider than the width of the medium PP in the direction intersecting the transport direction (Y1 direction) of the medium PP. To be specific, in the head unit HD according to the present embodiment, the plurality of nozzles N are provided so as to extend in a range wider than the width of the medium PP in the X1 direction intersecting the transport direction (Y1 direction) of the medium PP. Therefore, the head unit HD forms a desired image on the entire surface of the medium PP by ejecting ink from some or all of the plurality of nozzles N and causing the ejected ink to land on the surface of the medium PP in conjunction with the transport of the medium PP by the transport mechanism 91 under the control of the control device 90. Hereinafter, a process in which the liquid ejecting apparatus 100 forms an image on the medium PP may be referred to as a “printing process”.

The head unit HD includes two liquid ejecting heads 1, namely, a liquid ejecting head 1-1 and a liquid ejecting head 1-2. Hereinafter, the liquid ejecting head 1-1 and the liquid ejecting head 1-2 may be collectively referred to as the liquid ejecting heads 1-m. Here, the variable m is a natural number satisfying 1≤m≤2. In addition, hereinafter, of various constituent elements provided in the head unit HD, a constituent element corresponding to the liquid ejecting head 1-m may be expressed by adding a suffix “-m” to the reference numeral thereof.

The liquid ejecting head 1-1 includes four head chips 12. Each of the head chips 12 includes a plurality of nozzles N and ejects ink in the Z1 direction from some or all of the plurality of nozzles N under the control of the control signal SI.

Similarly to the liquid ejecting head 1-1, the liquid ejecting head 1-2 includes four head chips 12. The liquid ejecting head 1-2 is provided in the X1 direction when viewed from the liquid ejecting head 1-1.

The cleaning unit 94 performs a cleaning process. Here, the cleaning process is a process of cleaning each liquid ejecting head 1 provided in the head unit HD. Specifically, the cleaning process includes a suction cleaning process of sucking ink from each nozzle N provided in the liquid ejecting head 1 and a wiping process of wiping an ejection surface MF which is a surface in which the plurality of nozzles N are provided in the head unit HD, with a wiper (not illustrated).

The movement mechanism 95 moves the cleaning unit 94 to the positions in the head units HD where the cleaning process is to be performed.

### A.2. Outline of Head Unit HD

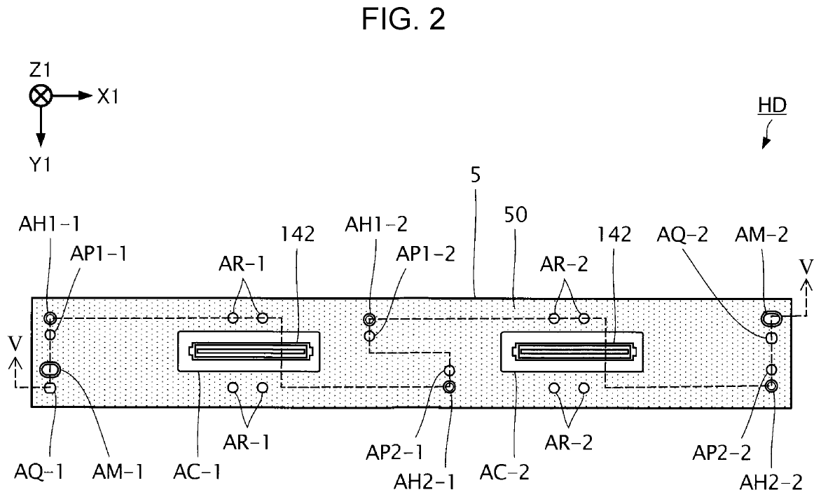

Hereinafter, an outline of the head unit HD will be described with reference to FIGS. 2 to 5.

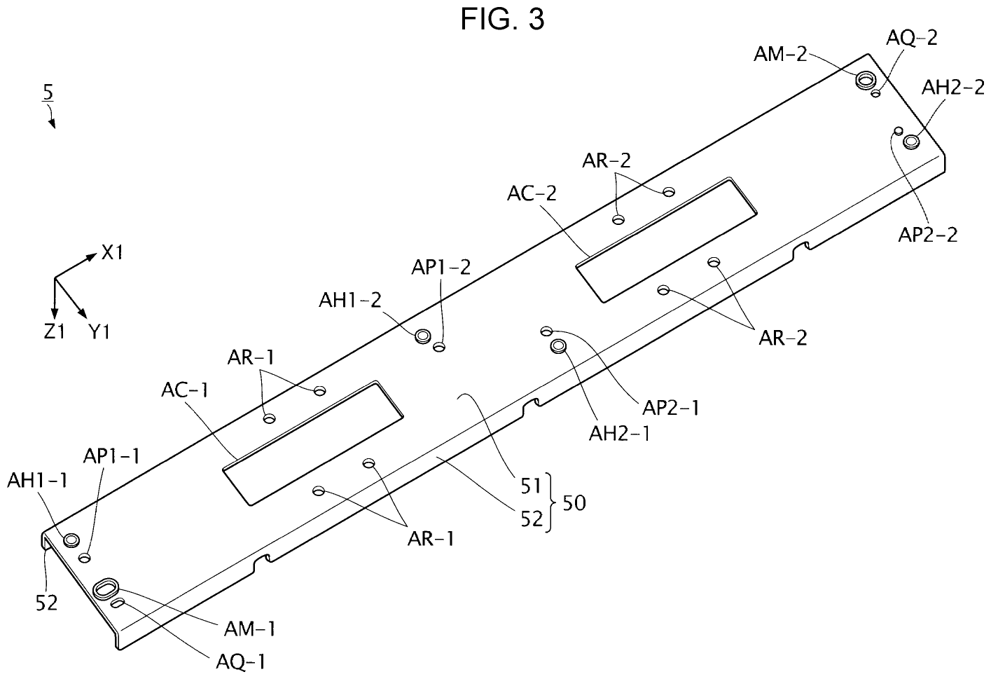

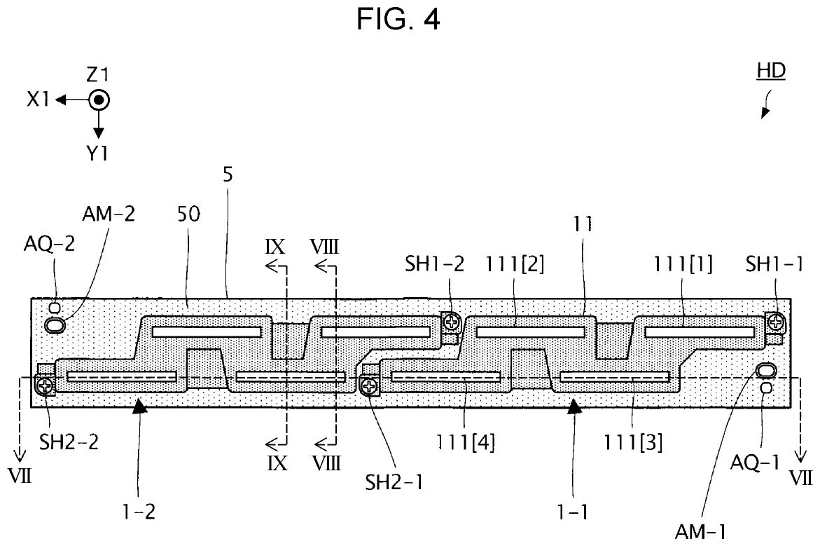

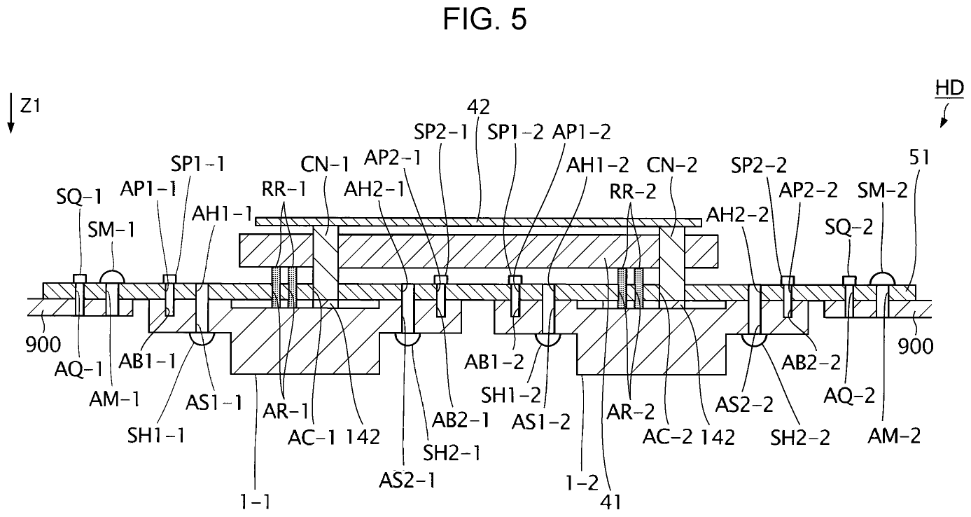

FIG. 2 is a plan view of the head unit HD in the Z1 direction. FIG. 3 is a perspective view of a support member 5 included in the head unit HD. FIG. 4 is a plan view of the head unit HD in the Z2 direction. FIG. 5 is a cross-sectional view of the head unit HD taken along line V-V in FIG. 2.

As illustrated in FIGS. 2 to 5, the head unit HD includes the two liquid ejecting heads 1 which are the liquid ejecting head 1-1 and the liquid ejecting head 1-2, the support member 5 which supports the two liquid ejecting heads 1, a common flow path member 41 in which various flow paths are provided, and a common electrical member 42 which is a rigid substrate in which various electronic components are provided. The head unit HD is fixed to a main body frame 900 of the liquid ejecting apparatus 100.

As illustrated in FIG. 3, the support member 5 includes a support plate 50 including a flat plate portion 51 and two bent portions 52, and also includes various openings provided in the flat plate portion 51.

The flat plate portion 51 is a flat plate-shaped member extending in a plane having a normal direction parallel to the Z-axis direction, and is a rectangular member elongated in the X-axis direction.

Each bent portion 52 is a flat plate-shaped member extending in a plane having a normal direction parallel to the Y-axis direction, and is a rectangular member elongated in the X-axis direction.

The present embodiment is based on the assumption that the flat plate portion 51 and the bent portions 52 are made of a metal. For example, in the present embodiment, both end portions in the Y-axis direction of a metal plate extending in a plane having a normal direction parallel to the Z-axis direction may be bent in the Z1 direction so that the bent end portions of the metal plate serve as the bent portions 52 and the portion of the metal plate between the two bent portions 52 serves as the flat plate portion 51.

In the present embodiment, a metal plate forming the flat plate portion 51 may be an iron-based metal plate such as SPCC (Steel Plate Cold Commercial), SECC (Steel Electrolytic Cold Commercial), or SGCC (Steel Galvanized Cold Commercial), a stainless steel-based metal plate such as SUS304 or SUS316, or an aluminum-based metal plate such as A1100 or A5052.

In addition, the metal plate forming the flat plate portion 51 is preferably thin enough to be bent. To be more specific, the thickness of the metal plate forming the flat plate portion 51 is preferably 6 mm or less, more preferably 3 mm or less. On the other hand, the metal plate forming the flat plate portion 51 is preferably thick enough to have a necessary strength. To be specific, the thickness of the metal plate forming the flat plate portion 51 is preferably 0.8 mm or more.

As illustrated in FIGS. 2 and 3, the flat plate portion 51 includes a plurality of openings.

To be specific, the flat plate portion 51 includes, for each liquid ejecting head 1, two head fixing screw holes AH which are a head fixing screw hole AH1 and a head fixing screw hole AH2, two head positioning holes AP which are a head positioning hole AP1 and a head positioning hole AP2, a frame fixing screw hole AM, a frame positioning hole AQ, an electrical connection opening AC, and a plurality of connection flow path openings AR.

To be more specific, the flat plate portion 51 includes head fixing screw holes AH1-1 and AH2-1 and head positioning holes AP1-1 and AP2-1 for the liquid ejecting head 1-1, and includes head fixing screw holes AH1-2 and AH2-2 and head positioning holes AP1-2 and AP2-2 for the liquid ejecting head 1-2. In addition, the flat plate portion 51 includes a frame fixing screw hole AM-1 and a frame positioning hole AQ-1 for the liquid ejecting head 1-1, and includes a frame fixing screw hole AM-2 and a frame positioning hole AQ-2 for the liquid ejecting head 1-2. In addition, the flat plate portion 51 includes an electrical connection opening AC-1 and a plurality of connection flow path openings AR-1 for the liquid ejecting head 1-1, and includes an electrical connection opening AC-2 and a plurality of connection flow path openings AR-2 for the liquid ejecting head 1-2.

As described above, the liquid ejecting head 1 includes the four head chips 12. Hereinafter, of the four head chips 12 included in the liquid ejecting head 1, the j-th head chip 12 may be referred to as the head chip 12[j]. Here, the variable j is a natural number satisfying 1≤j ≤4. Hereinafter, of various constituent elements provided in the liquid ejecting head 1, a constituent element corresponding to the head chip 12[j] may be expressed by adding a suffix [j] to the reference numeral thereof.

As illustrated in FIG. 4, the liquid ejecting head 1 includes a fixing plate 11. The fixing plate 11 is provided with four nozzle exposure openings 111 corresponding to the four head chips 12 included in the liquid ejecting head 1. Hereinafter, of the four nozzle exposure openings 111 provided in the fixing plate 11, the nozzle exposure opening 111 provided to correspond to the head chip 12[j] may be referred to as the nozzle exposure opening 111[j]. The nozzle exposure opening 111[j] is an opening for exposing the plurality of nozzles N provided in the head chip 12[j] in the Z1 direction of the head unit HD.

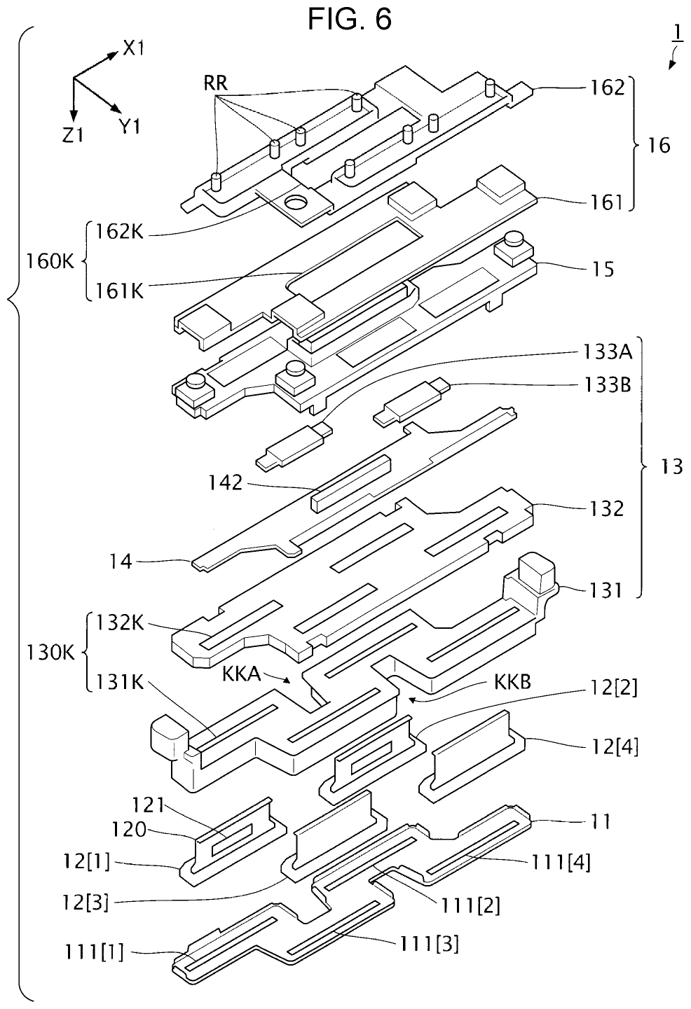

In the present embodiment, as illustrated in FIG. 4 (and FIG. 6 which will be described later), it is assumed that the head chip 12[2] and the nozzle exposure opening 111[2] are provided in a region positioned in the X1 direction when viewed from the head chip 12[1] and the nozzle exposure opening 111[1]. In addition, in the present embodiment, it is assumed that the head chip 12[3] and the nozzle exposure opening 111[3] are provided in a region positioned in a direction between the X1 direction and the Y1 direction when viewed from the head chip 12[1] and the nozzle exposure opening 111[1]. In addition, in the present embodiment, it is assumed that the head chip 12[4] and the nozzle exposure opening 111[4] are provided in a region positioned in the X1 direction when viewed from the head chip 12[3] and the nozzle exposure opening 111[3].

As illustrated in FIG. 5, each liquid ejecting head 1 is provided with two support-plate fixing screw holes AS, namely, a support-plate fixing screw hole AS1 and a support-plate fixing screw hole AS2, and two support-plate positioning holes AB, namely, a support-plate positioning hole AB1 and a support-plate positioning hole AB2.

To be specific, the liquid ejecting head 1-1 is provided with two support-plate fixing screw holes AS, namely, a support-plate fixing screw hole AS1-1 and a support-plate fixing screw hole AS2-1, and two support-plate positioning holes AB, namely, a support-plate positioning hole AB1-1 and a support-plate positioning hole AB2-1. In addition, the liquid ejecting head 1-2 is provided with two support-plate fixing screw holes AS, namely, a support-plate fixing screw hole AS1-2 and a support-plate fixing screw hole AS2-2, and two support-plate positioning holes AB, namely, a support-plate positioning hole AB1-2 and a support-plate positioning hole AB2-2.

As illustrated in FIG. 5, a head fixing screw SH1 is inserted into the head fixing screw hole AH1 and the support-plate fixing screw hole AS1 provided to correspond to each liquid ejecting head 1, and a head fixing screw SH2 is inserted into the head fixing screw hole AH2 and the support-plate fixing screw hole AS2 provided to correspond to each liquid ejecting head 1. In addition, a head positioning pin SP1 is inserted into the head positioning hole AP1 and the support-plate positioning hole AB1 provided to correspond to each liquid ejecting head 1, and a head positioning pin SP2 is inserted into the head positioning hole AP2 and the support-plate positioning hole AB2 provided to correspond to each liquid ejecting head 1.

To be specific, a head fixing screw SH1-1 is inserted into the head fixing screw hole AH1-1 and the support-plate fixing screw hole AS1-1 provided to correspond to the liquid ejecting head 1-1, and a head fixing screw SH2-1 is inserted into the head fixing screw hole AH2-1 and the support-plate fixing screw hole AS2-1 provided to correspond to the liquid ejecting head 1-1. In addition, a head positioning pin SP1-1 is press-fitted into the head positioning hole AP1-1 and the support-plate positioning hole AB1-1 provided to correspond to liquid ejecting head 1-1, and a head positioning pin SP2-1 is press-fitted into the head positioning hole AP2-1 and the support-plate positioning hole AB2-1 provided to correspond to the liquid ejecting head 1-1. In addition, a head fixing screw SH1-2 is inserted into the head fixing screw hole AH1-2 and the support-plate fixing screw hole AS1-2 provided to correspond to the liquid ejecting head 1-2, and a head fixing screw SH2-2 is inserted into the head fixing screw hole AH2-2 and the support-plate fixing screw hole AS2-2 provided to correspond to the liquid ejecting head 1-2. In addition, a head positioning pin SP1-2 is press-fitted into the head positioning hole AP1-2 and the support-plate positioning hole AB1-2 provided to correspond to the liquid ejecting head 1-2, and a head positioning pin SP2-2 is press-fitted into the head positioning hole AP2-2 and the support-plate positioning hole AB2-2 provided to correspond to the liquid ejecting head 1-2.

As illustrated in FIG. 5, the flow paths provided in each liquid ejecting head 1 communicate with the flow paths provided in the common flow path member 41 via connection flow paths RR inserted into the connection flow path openings AR.

In addition, the electronic components provided in each liquid ejecting head 1 are electrically connected to electronic components provided in the common electrical member 42 via a B-to-B connector CN inserted into the corresponding electrical connection opening AC. Here, the electronic components provided on the common electrical member 42 and a relay substrate 14 are wiring, capacitors, resistors, ICs, and the like. A B-to-B connector is also referred to as a board-to-board connector. B-to-B is an acronym for Board to Board. A B-to-B connector is a connector that directly connects two substrates without a cable. The B-to-B connectors of the present embodiment are, for example, a so-called straight type in which a fitting surface of the connector and the surface of the substrate to which the connector is attached are substantially parallel to each other. The B-to-B connectors CN are provided on a surface of the common electrical member 42 facing the Z1 direction. Although in the present embodiment, the B-to-B connectors CN are inserted into the electrical connection openings AC, but the present disclosure is not limited to such a configuration. B-to-B connectors 142 of the liquid ejecting heads 1 may be inserted into the electrical connection openings AC, or a flexible board such as an FFC or a rigid board for electrically connecting the common electrical member 42 and the relay substrate 14 may be used.

Specifically, the flow paths provided in the liquid ejecting head 1-1 communicate with the flow paths provided in the common flow path member 41 via the plurality of connection flow paths RR-1 provided to correspond to the plurality of connection flow path openings AR-1. In addition, the flow paths provided in the liquid ejecting head 1-2 communicate with the flow paths provided in the common flow path member 41 via the plurality of connection flow paths RR-2 provided to correspond to the plurality of connection flow path openings AR-2. In addition, the electronic components provided in the liquid ejecting head 1-1 and electronic components provided in the common electrical member 42 are electrically connected with the B-to-B connector CN-1 inserted into the electrical connection opening AC-1. In addition, the electronic components provided in the liquid ejecting head 1-2 and electronic components provided in the common electrical member 42 are electrically connected with the B-to-B connector CN-2 inserted into the electrical connection opening AC-2.

As illustrated in FIG. 5, a frame fixing screw SM is inserted into the frame fixing screw hole AM provided to correspond to each liquid ejecting head 1, and a frame positioning pin SQ is inserted into the frame positioning hole AQ provided to correspond to each liquid ejecting head 1.

Specifically, a frame fixing screw SM-1 is inserted into the frame fixing screw hole AM-1 provided to correspond to the liquid ejecting head 1-1, and a frame positioning pin SQ-1 is inserted into the frame positioning hole AQ-1 provided to correspond to the liquid ejecting head 1-1. Further, a frame fixing screw SM-2 is inserted into the frame fixing screw hole AM-2 provided to correspond to the liquid ejecting head 1-2, and a frame positioning pin SQ-2 is inserted into the frame positioning hole AQ-2 provided to correspond to the liquid ejecting head 1-2.

In the present embodiment, as illustrated in FIG. 3, since the head fixing screw holes AH, the head positioning holes AP, the frame fixing screw holes AM, and the frame positioning holes AQ are disposed in straight lines in the Y-axis direction, it is possible to reduce the size of the liquid ejecting head 1 in the X-axis direction.

Further, in the present embodiment, as illustrated in FIG. 3, since the combination of the frame fixing screw hole AM-1 and the frame positioning hole AQ-1 and the combination of the frame fixing screw hole AM-2 and the frame positioning hole AQ-2 are arranged diagonally in the flat plate portion 51, the positioning accuracy of the support member 5 with respect to the main body frame 900 is improved, for example, compared with configurations in which they are arranged close to each other.

In addition, in the present embodiment, as illustrated in FIG. 3, since the combination of a head fixing screw hole AH1 and a head positioning hole AP1 and the combination of a head fixing screw hole AH2 and a head positioning hole AP2 are arranged diagonally with respect to each liquid ejecting head 1, the positioning accuracy of the liquid ejecting head 1 with respect to the support member 5 is improved, for example, compared with configurations in which they are arranged close to each other.

Further, in the present embodiment, as illustrated in FIG. 5, since the head positioning pins SP and the frame positioning pins SQ are arranged on the same surface (a lower surface P511 described later) of the flat plate portion 51, it is possible to increase the positioning accuracy of the liquid ejecting head 1 with respect to the main body frame 900, compared with configurations in which they are arranged on the surfaces opposite to each other of the flat plate portion 51.

### A.3. Configuration of Liquid Ejecting Head 1

Hereinafter, an outline of the configuration of the liquid ejecting head 1 will be described with reference to FIGS. 6 to 9.

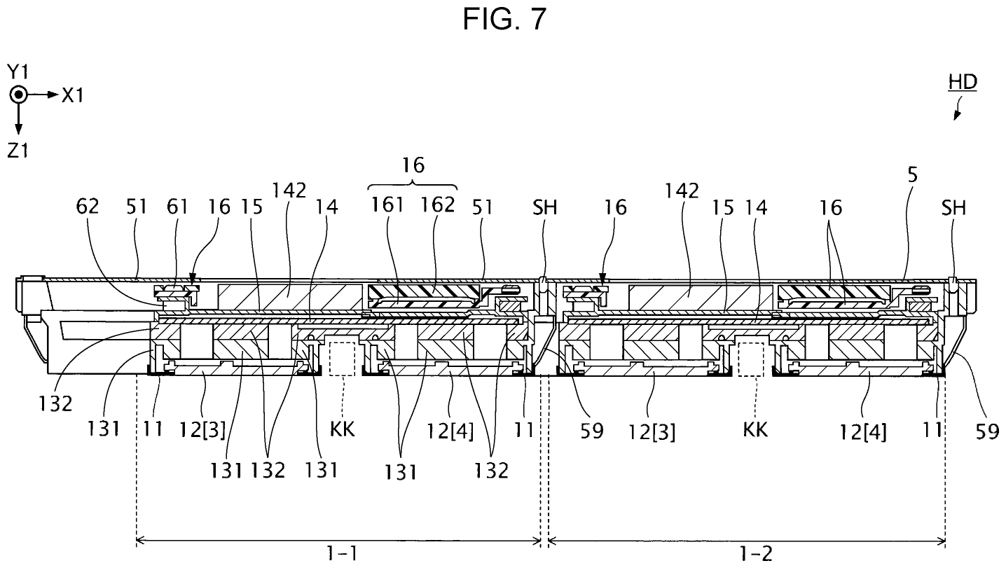

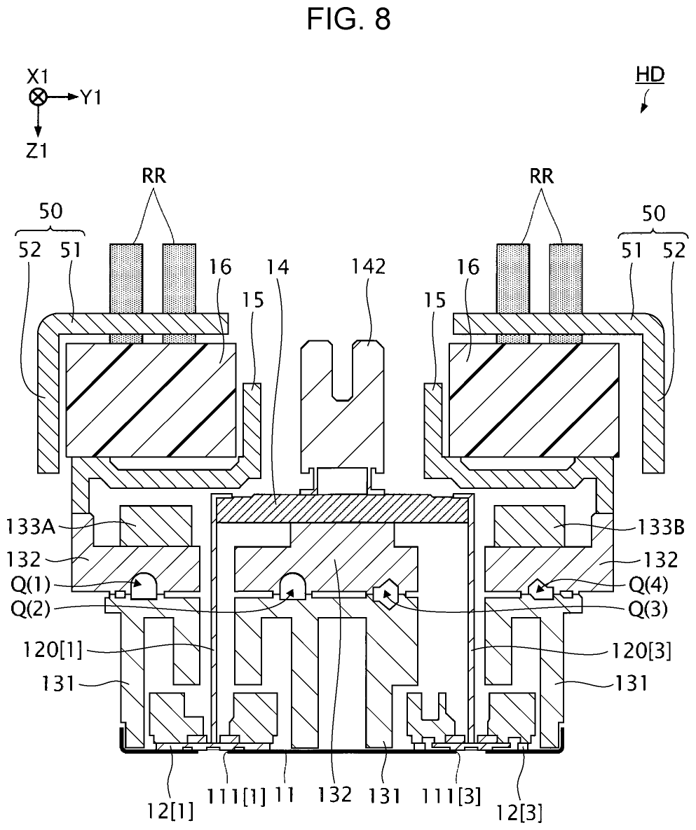

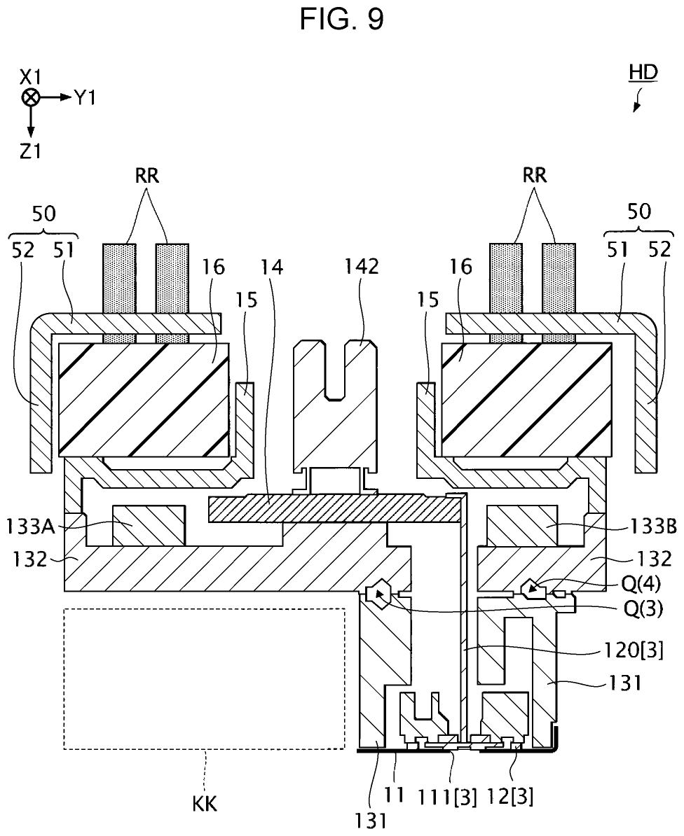

FIG. 6 is an exploded perspective view of the liquid ejecting head 1. FIG. 7 is a cross-sectional view of the head unit HD including the liquid ejecting head 1-1 and the liquid ejecting head 1-2 taken along line VII-VII in FIG. 4. FIG. 8 is a cross-sectional view of the head unit HD including the liquid ejecting head 1 taken along the line VIII-VIII in FIG. 4. FIG. 9 is a cross-sectional view of the head unit HD including the liquid ejecting head 1 taken along the line IX-IX in FIG. 4.

As illustrated in FIG. 6, the liquid ejecting head 1 includes the fixing plate 11, the head chips 12[1] to 12[4], a holder 13, the relay substrate 14, a substrate cover 15, and a filter unit 16. Among these, the holder 13 includes a lower holder 131, an intermediate holder 132, and two upper holders 133 which are an upper holder 133A and an upper holder 133B. Further, the filter unit 16 includes a lower filter unit 161 and an upper filter unit 162.

As illustrated in FIG. 6, the fixing plate 11 is a plate-like member elongated in the X-axis direction, and is made of, for example, a metal. As described above, the four nozzle exposure openings 111[1] to 111[4] are provided in the fixing plate 11. The nozzle exposure opening 111[j] is an opening for exposing the plurality of nozzles N included in the head chip 12[j] to the lower side of the fixing plate 11. In the present embodiment, as described above, in the fixing plate 11, the nozzle exposure opening 111[2] is provided in a region positioned in the X1 direction when viewed from the nozzle exposure opening 111[1], the nozzle exposure opening 111[3] is provided in a region positioned in a direction between the X1 direction and the Y1 direction when viewed from the nozzle exposure opening 111[1], and the nozzle exposure opening 111[4] is provided in a region positioned in the X1 direction when viewed from the nozzle exposure opening 111[3].

As illustrated in FIG. 7, the fixing plate 11 is electrically connected to the flat plate portion 51 of the support member 5 with a grounding spring 59.

As illustrated in FIGS. 6 to 9, the head chips 12[1] to 12[4] are provided on the upper side of the fixing plate 11. Specifically, in the present embodiment, the plurality of head chips 12 are fixed to the upper surface of the fixing plate 11 with an adhesive. As described above, in the fixing plate 11, the head chip 12[2] is fixed in a region positioned in the X1 direction when viewed from the head chip 12[1], the head chip 12[3] is fixed in a region positioned in a direction between the X1 direction and the Y1 direction when viewed from the head chip 12[1], and the head chip 12[4] is fixed in a region positioned in the X1 direction when viewed from the head chip 12[3].

As illustrated in FIG. 6, each head chip 12 includes the ejection surface MF (refer to FIG. ; 18) in which the plurality of nozzles N that eject ink in the Z1 direction are provided. A wiring circuit board 120 is connected to the head chip 12. The wiring circuit board 120 is, for example, a flexible printed circuit (FPC), and is provided so as to extend in the Z2 direction from the upper surface of the head chip 12. In the present embodiment, a drive control circuit 121 is mounted on the wiring circuit board 120. The drive control circuit 121 is a circuit for driving the head chip 12 based on the control signal SI by supplying the drive signal Com to the head chip 12, based on the control signal SI.

As illustrated in FIGS. 6 to 9, the lower holder 131 is provided on the upper side of the head chips 12[1] to 12[4]. Specifically, in the present embodiment, the lower holder 131 is fixed to the fixing plate 11 with an adhesive so as to hold the head chips 12[1] to 12[4] between the lower holder 131 and the fixing plate 11. The lower holder 131 is a member elongated in the X-axis direction, and is made of, for example, a resin or a metal. The lower holder 131 is provided with four wiring openings 131K[1] to 131K[4] corresponding to the four head chips 12[1] to 12[4]. The wiring circuit board 120[j] is inserted into the wiring opening 131K[j]. Further, the lower holder 131 is provided with a cutout portion KKA and a cutout portion KKB. The cutout portion KKA is provided between the wiring opening 131K[1] and the wiring opening 131K[2], and is a recess which is provided in the end surface of the lower holder 131 in the Y2 direction and is recessed in the Y1 direction. The cutout portion KKB is provided between the wiring opening 131K[3] and the wiring opening 131K[4], and is a recess which is provided in the end surface of the lower holder 131 in the Y1 direction and is recessed in the Y2 direction. Hereinafter, the cutout portion KKA and the cutout portion KKB may be collectively referred to as the cutout portions KK.

As illustrated in FIGS. 6 to 9, the intermediate holder 132 is provided on the upper side of the lower holder 131. Specifically, in the present embodiment, the intermediate holder 132 is fixed to the upper surface of the lower holder 131 with an adhesive. The intermediate holder 132 is a member elongated in the X-axis direction, and is made of, for example, a resin or a metal. The intermediate holder 132 is provided with four wiring openings 132K[1] to 132K[4] corresponding to the four head chips 12[1] to 12[4]. The wiring circuit board 120[j] is inserted into the wiring opening 132K[j]. Hereinafter, the wiring opening 131K[j] and the wiring opening 132K[j] are referred to as the wiring opening 130K[j].

As illustrated in FIGS. 6 to 9, the relay substrate 14 is provided on the upper side of the intermediate holder 132. Specifically, in the present embodiment, the relay substrate 14 is fixed to the upper surface of the intermediate holder 132 with an adhesive. The relay substrate 14 is a member elongated in the X-axis direction, in which various electronic components are mounted on a base material made of a resin, for example.

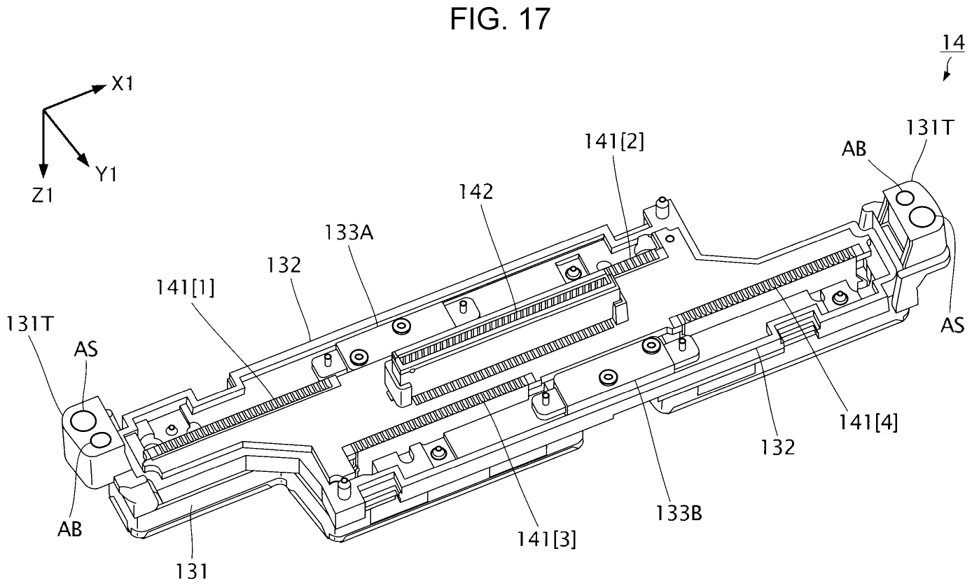

As illustrated in FIGS. 8 and 9, the four wiring circuit boards 120[1] to 120[4] are connected to the relay substrate 14. That is, the relay substrate 14 is electrically connected to the head chip 12[j] via the wiring circuit board 120[j]. In addition, the relay substrate 14 is provided with the B-to-B connector 142. The B-to-B connector 142 is provided so as to extend in the Z2 direction from the upper surface of the relay substrate 14, and is connected to the B-to-B connector CN. That is, the relay substrate 14 is electrically connected to the common electrical member 42 via the B-to-B connector 142 and the B-to-B connector CN. The structure of the relay substrate 14 will be described in detail later with reference to FIG. 17.

As illustrated in FIGS. 6, 8, and 9, the upper holders 133 are provided on the upper side of the intermediate holder 132. Specifically, in the present embodiment, the upper holders 133 are fixed to the upper surface of the intermediate holder 132 with an adhesive. To be more specific, the upper holder 133A is fixed to the upper surface of the intermediate holder 132 at a position over the cutout portion KKA. Further, the upper holder 133B is fixed to the upper surface of the intermediate holder 132 at a position over the cutout portion KKB. Each upper holder 133 is a member elongated in the X-axis direction, and is made of, for example, a resin or a metal.

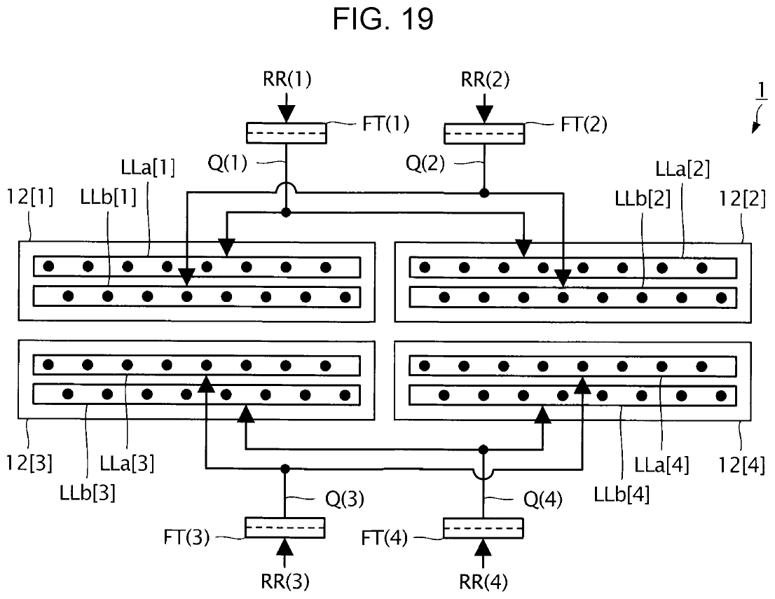

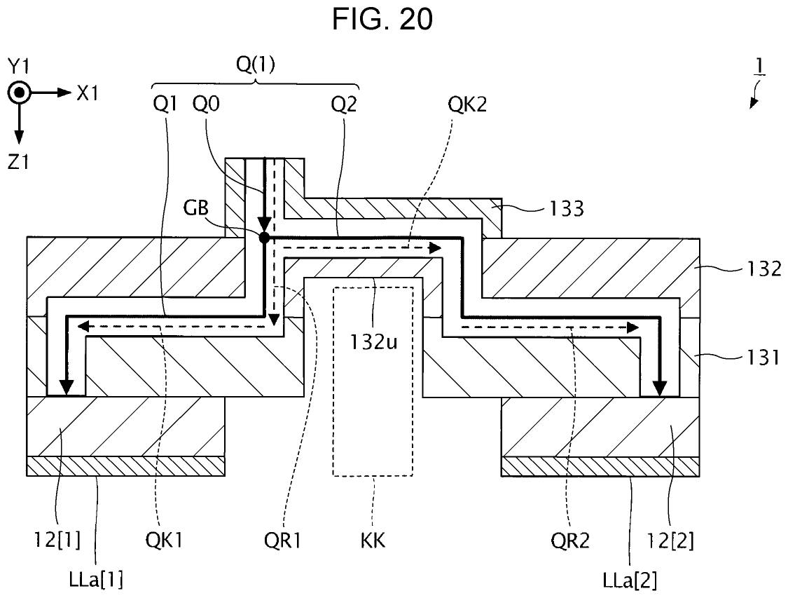

As illustrated in FIGS. 8 and 9, a plurality of supply flow paths Q for supplying ink to the four head chips 12[1] to 12[4] included in the liquid ejecting head 1 are provided in the holder 13 including the lower holder 131, the intermediate holder 132, and the upper holders 133. The present embodiment is based on the assumption that ink is supplied to the four head chips 12[1] to 12[4] included in the liquid ejecting head 1 by using four supply flow paths Q. Hereinafter, of the four supply flow paths Q, the u-th supply flow path Q is referred to as the supply flow path Q(u). Here, the variable u is a natural number satisfying 1≤u≤4. Details of the supply flow paths Q will be described later with reference to FIGS. 19 and 20.

As illustrated in FIGS. 6 to 9, the substrate cover 15 is provided on the upper sides of the upper holders 133 and the relay substrate 14. Specifically, in the present embodiment, the substrate cover 15 may be fixed to the upper surface of the intermediate holder 132 with an adhesive, or may be detachably fixed to the intermediate holder 132 by snap-fitting. The substrate cover 15 is a member elongated in the X-axis direction, and is made of, for example, a resin or a metal.

As illustrated in FIGS. 6 to 9, the filter unit 16 is provided on the upper side of the substrate cover 15. As illustrated in FIG. 7, in the present embodiment, the filter unit 16 is fixed to the substrate cover 15 with filter fixing screws 61 and nuts 62. As illustrated in FIGS. 6 and 7, the filter unit 16 includes the lower filter unit 161 and the upper filter unit 162 provided on the upper side of the lower filter unit 161.

The lower filter unit 161 is a member elongated in the X-axis direction, and is made of, for example, a resin. The lower filter unit 161 is provided with flow paths which communicate with the supply flow paths Q. Further, the lower filter unit 161 is provided with an electrical connection opening 161K. The B-to-B connector 142 is inserted into the electrical connection opening 161K.

The upper filter unit 162 is a member elongated in the X-axis direction, and is made of, for example, a resin. The upper filter unit 162 is provided with connection flow paths RR and flow paths which communicate with the connection flow paths RR. As illustrated in FIGS. 6, 8 to 11, and the like, the connection flow paths RR are formed inside flow path pipes provided so as to protrude in the Z2 direction from the upper side of the upper filter unit 162. The flow paths provided in the upper filter unit 162 communicate with the flow paths provided in the lower filter unit 161. Further, the upper filter unit 162 is provided with an electrical connection opening 162K. The B-to-B connector 142 is inserted into the electrical connection opening 162K. Hereinafter, the electrical connection opening 161K and the electrical connection opening 162K will be referred to as the electrical connection opening 160K. In addition, the connection flow paths RR which are inserted into the connection flow path openings AR may be formed inside flow path pipes which protrude from the lower surface of the common flow path member 41 in the Z1 direction, or may be formed inside flexible tubes for connecting the common flow path member 41 and the liquid ejecting heads 1 in a liquid tight manner.

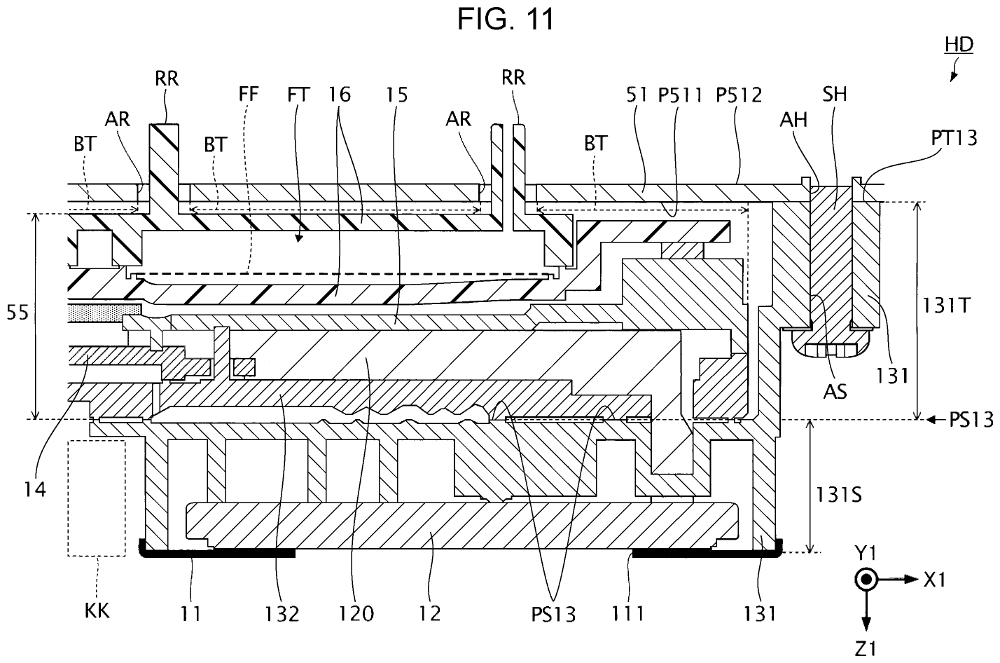

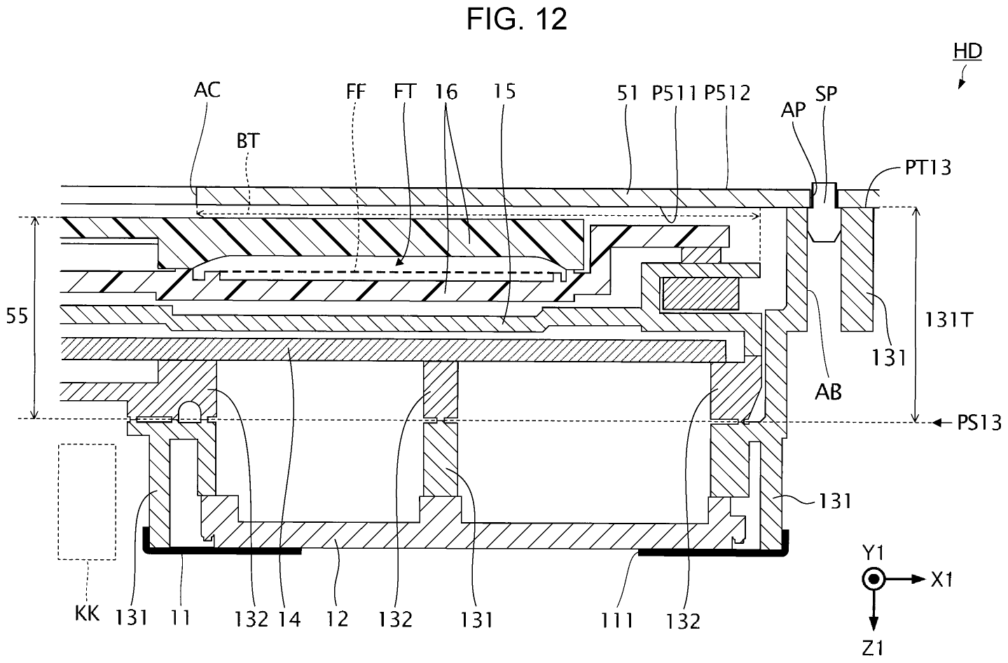

In addition, the filter unit 16 is provided with filter chambers FT in which filters FF are disposed (refer to FIGS. 11 and 12 described later). The filter chambers FT communicate with the connection flow paths RR and the supply flow paths Q. The filters FF have configurations for removing air bubbles and foreign matter contained in the ink supplied from the liquid container 93 via the connection flow paths RR. The ink supplied from the liquid container 93 via the connection flow paths RR is supplied to the supply flow paths Q after air bubbles and foreign matter are removed in the filters FF provided in the filter chamber FT.

As illustrated in FIGS. 8 and 9, the flat plate portion 51 is provided on the upper side of the filter unit 16 included in the liquid ejecting head 1. In addition, the bent portions 52 are provided in a region positioned in the Y1 direction when viewed from the filter unit 16 and a region positioned in the Y2 direction when viewed from the filter unit 16.

Hereinafter, in the liquid ejecting head 1, the components provided on the upper side of the lower holder 131, that is, the components including the intermediate holder 132, the upper holders 133, the relay substrate 14, the substrate cover 15, and the filter unit 16 may be referred to as the multilayer structure 55.

### A.4. Relationship between Liquid Ejecting Head 1 and Support Member 5

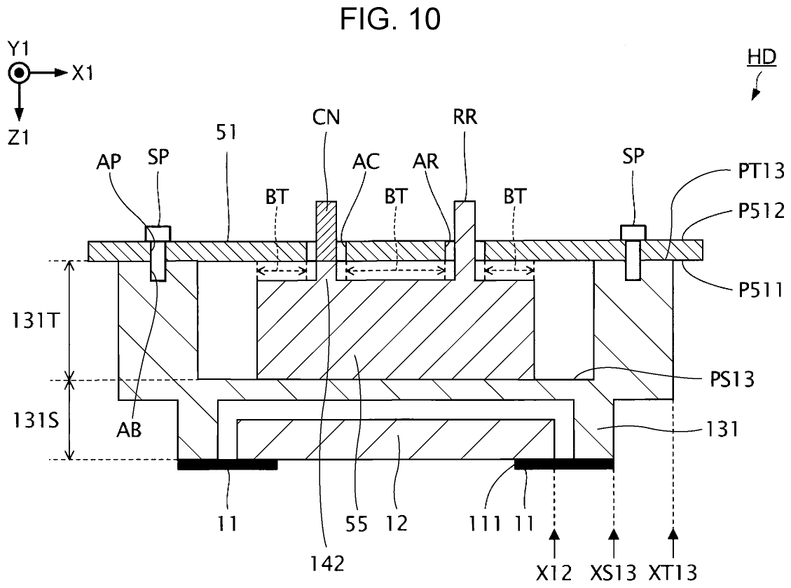

Hereinafter, the positional relationship between the liquid ejecting head 1 and the support member 5 will be described with reference to FIGS. 10 to 16.

### A.4.1. Configurations of Liquid Ejecting Head 1 and Support Member 5

FIG. 10 is a schematic diagram illustrating a cross section of the head unit HD taken along a plane having a normal direction parallel to the Y-axis direction. FIG. 11 is a cross-sectional view of the head unit HD taken along a plane that passes through a support-plate fixing screw hole AS and has a normal direction parallel to the Y-axis direction. FIG. 12 is a cross-sectional view of the head unit HD taken along a plane that passes through a support-plate positioning hole AB and has a normal direction parallel to the Y-axis direction.

As illustrated in FIGS. 10 to 12, as described above, the head unit HD includes the fixing plate 11 to which the head chips 12 are fixed, the lower holder 131 which houses the head chips 12 between the lower holder 131 and the fixing plate 11 and is fixed to the fixing plate 11, the multilayer structure 55 stacked on the lower holder 131, and the flat plate portion 51 which is fixed onto the lower holder 131.

The lower holder 131 includes a mounting surface PS13. The mounting surface PS13 is a surface whose normal direction is the Z2 direction, and is a surface for mounting the multilayer structure 55. In the present embodiment, the multilayer structure 55 is stacked on the mounting surface PS13 in the Z2 direction.

In addition, the lower holder 131 includes a housing portion 131S and protruding portions 131T. The housing portion 131S and the protruding portions 131T are integrally formed by injection molding or the like using a mold, and are not separate components fixed to each other by bonding or joining.

The housing portion 131S is a portion of the lower holder 131 below the mounting surface PS13, and has a portion which overlaps the head chips 12 when viewed in the X-axis direction. The housing portion 131S houses the head chips 12 between the housing portion 131S and the fixing plate 11.

The protruding portions 131T are portions of the lower holder 131 above the mounting surface PS13, and have portions that overlap the multilayer structure 55 when viewed in the X-axis direction. Further, the protruding portions 131T include contact surfaces PT13. The contact surfaces PT13 are surfaces whose normal directions are the Z2 direction, and are surfaces located at end portions of the protruding portions 131T in the Z2 direction. The contact surfaces PT13 are in contact with the flat plate portion 51. Hereinafter, of the surfaces of the flat plate portion 51, the lower surface of the flat plate portion 51 whose normal direction is the Z1 direction is referred to as the lower surface P511, and the upper surface of the flat plate portion 51 whose normal direction is the Z2 direction is referred to as the upper surface P512. The contact surfaces PT13 are in contact with the lower surface P511.

The multilayer structure 55 includes a facing portion BT and non-facing portions BH.

The facing portion BT is a portion of the multilayer structure 55 that faces the lower surface P511 of the flat plate portion 51. That is, the facing portion BT is a portion that overlaps the flat plate portion 51 in a plan view of the multilayer structure 55 in the Z1 direction.

The non-facing portions BH are portions of the multilayer structure 55 that do not face the lower surface P511 of the flat plate portion 51. To be specific, the non-facing portions BH are portions which overlap openings such as the electrical connection openings AC and the connection flow path openings AR which are provided in the flat plate portion 51 in a plan view of the multilayer structure 55 in the Z1 direction.

In the present embodiment, in a plan view of the head unit HD in the Z1 direction, the area of the facing portion BT is larger than the area of the non-facing portions BH in the multilayer structure 55. In addition, in the present embodiment, in a plan view of the head unit HD in the Z1 direction, the area of each of the plurality of openings such as the electrical connection openings AC and the connection flow path openings AR provided in the flat plate portion 51 is smaller than the area of the ejection surface MF of each head chip 12.

As described above, the head positioning holes AP are provided in the flat plate portion 51. Further, the support-plate positioning holes AB are provided in the protruding portions 131T. The head positioning pins SP are press-fitted into the head positioning holes AP and the support-plate positioning holes AB, whereby the lower holder 131 is positioned with respect to the support member 5. Thus, the head chips 12 are positioned with respect to the support member 5.

As described above, the head fixing screw holes AH are provided in the flat plate portion 51. Further, the support-plate fixing screw holes AS are provided in the protruding portions 131T. Then, the lower holder 131 is fixed to the support member 5 by inserting the head fixing screws SH into the head fixing screw holes AH and the support-plate fixing screw holes AS. Thus, the liquid ejecting head 1 is fixed to the support member 5.

As illustrated in FIG. 10, the position in the X-axis direction of the end portion of the protruding portion 131T in the X1 direction is referred to as the position XT13. The position in the X-axis direction of the end portion of the housing portion 131S in the X1 direction is referred to as the position XS13. The position in the X-axis direction of the end portion in the X1 direction of the head chip 12[4] arranged at the end in the X1 direction among the plurality of head chips 12 is referred to as the position X12. Note that the head chip 12 in FIG. 10 schematically indicates the head chip 12[4]. In this case, the position XS13 is located between the position XT13 and the position X12 in the X-axis direction. That is, in the X-axis direction, the end portion of the housing portion 131S in the X1 direction is positioned between the end portion of the protruding portion 131T in the X1 direction and the end portion of the head chip 12 in the X1 direction. Similarly, in the X-axis direction, the end portion of the housing portion 131S in the X2 direction is positioned between the end portion of the protruding portion 131T in the X2 direction and the end portion of the head chip 12[1] arranged at the end in the X2 direction among the plurality of head chips 12.

As described above, according to the present embodiment, in the X-axis direction, the protruding portions 131T have shapes that protrude outward from the housing portion 131S. For this reason, according to the present embodiment, for example, it is possible to increase the size of the multilayer structure 55 which is disposed between the protruding portions 131T, compared with configurations in which the protruding portions 131T are located within the area of the housing portion 131S in the X-axis direction.

### A.4.2. Comparative Examples

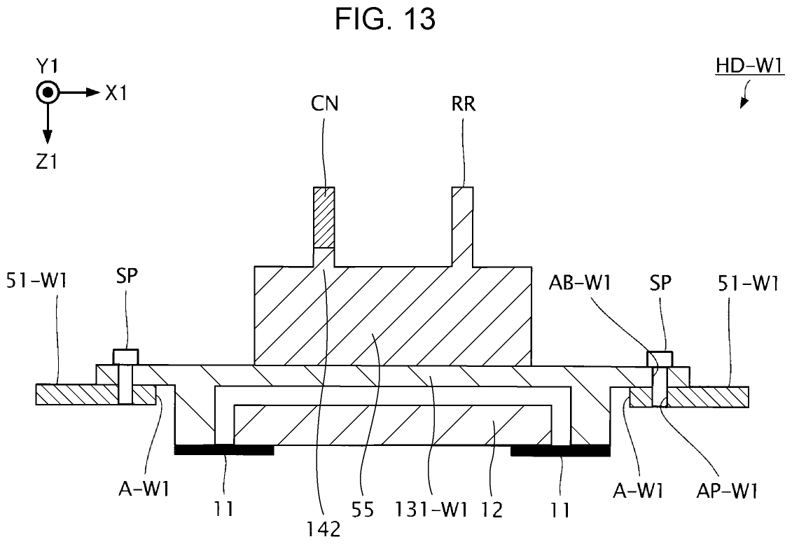

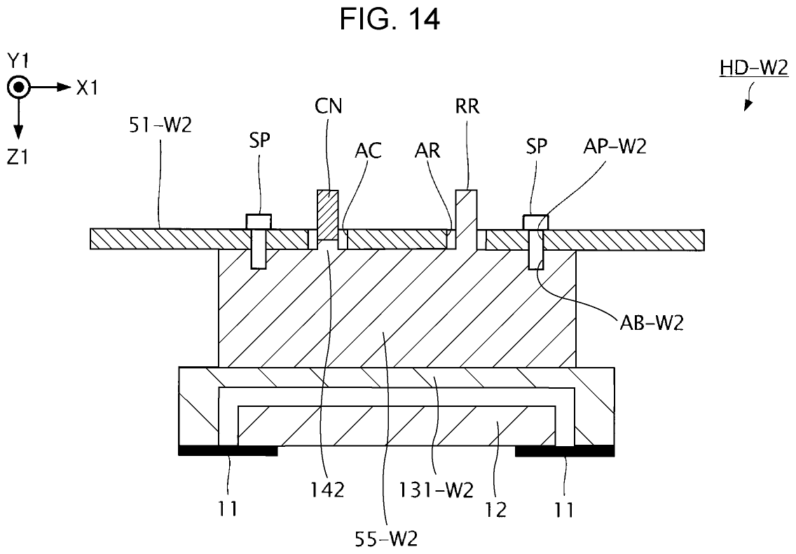

Hereinafter, in order to clarify the advantages of the present embodiment, head units according to comparative examples will be described with reference to FIGS. 13 and 14.

FIG. 13 is a schematic diagram illustrating a cross section of a head unit HD-W1 according to Comparative Example W1.

As illustrated in FIG. 13, the head unit HD-W1 according to Comparative Example W1 is different from the head unit HD according to the present embodiment in that the head unit HD-W1 includes a flat plate portion 51-W1 instead of the flat plate portion 51 and includes a lower holder 131-W1 instead of the lower holder 131.

Support-plate positioning holes AB-W1 are provided in the lower holder 131-W1. In addition, the multilayer structure 55 is stacked on the upper surface of the lower holder 131-W1 in the Z2 direction.

The flat plate portion 51-W1 is provided with head positioning holes AP-W1 and an opening A-W1. Here, the opening A-W1 is an opening for inserting a part or all of the head chip 12 including the ejection surface MF of the head chip 12 from the upper side to the lower side.

In Comparative Example W1, the lower holder 131-W1 is positioned with respect to the flat plate portion 51-W1 by press-fitting the head positioning pins SP into the head positioning holes AP-W1 and the support-plate positioning holes AB-W1.

As described above, in Comparative Example W1, the opening A-W1 for inserting the ejection surface MF is provided in the flat plate portion 51-W1. In a plan view in the Z1 direction, the opening A-W1 has a larger area than the ejection surface MF of the head chip 12. For this reason, in Comparative Example W1, there is a possibility that the flat plate portion 51-W1 cannot have a sufficient stiffness for supporting the liquid ejecting head including the head chips 12, the lower holder 131-W1, and the multilayer structure 55. This is particularly remarkable when the flat plate portion 51-W1 is formed of a metal plate.

In contrast, according to the present embodiment, the area of each opening provided in the flat plate portion 51 is smaller than the area of the ejection surface MF in a plan view in the Z1 direction. According to the present embodiment, since the area of the facing portion BT is smaller than the area of the non-facing portions BH in a plan view in the Z1 direction, the sum of the areas of the openings provided in the portion of the flat plate portion 51 overlapping the multilayer structure 55 in a plan view in the Z1 direction is smaller than the sum of the areas of the portions where the openings are not provided. For this reason, according to the present embodiment, it is possible to increase the stiffness of the flat plate portion 51, compared with Comparative Example W1.

FIG. 14 is a schematic diagram illustrating a cross section of a head unit HD-W2 according to Comparative Example W2.

As illustrated in FIG. 14, the head unit HD-W2 according to Comparative Example W2 is different from the head unit HD according to the present embodiment in that the head unit HD-W2 includes a flat plate portion 51-W2 instead of the flat plate portion 51, includes a lower holder 131-W2 instead of the lower holder 131, and includes a multilayer structure 55-W2 instead of the multilayer structure 55.

On the upper surface of the lower holder 131-W2, the multilayer structure 55-W2 is stacked in the Z2 direction. The lower holder 131-W2 is different from the lower holder 131 according to the present embodiment in that the lower holder 131-W2 is not in contact with the flat plate portion 51-W2.

The multilayer structure 55-W2 is different from the multilayer structure 55 according to the present embodiment in that the multilayer structure 55-W2 is provided with support-plate positioning holes AB-W2.

The flat plate portion 51-W2 is provided with head positioning holes AP-W2, a plurality of electrical connection openings AC, and a plurality of connection flow path openings AR. That is, the flat plate portion 51-W2 is different from the flat plate portion 51 according to the present embodiment in that the flat plate portion 51-W2 is provided with the head positioning holes AP-W2 instead of the head positioning holes AP.

By press-fitting the head positioning pins SP into the head positioning holes AP-W2 and the support-plate positioning holes AB-W2, the multilayer structure 55-W2 and the lower holder 131-W2 are positioned with respect to the flat plate portion 51-W2.

According to Comparative Example W2, the area of each opening provided in the flat plate portion 51-W2 is smaller than the area of the ejection surface MF in a plan view in the Z1 direction. In addition, according to Comparative Example W2, the sum of the areas of the openings provided in the portion of the flat plate portion 51-W2 overlapping the multilayer structure 55-W2 is smaller than the sum of the areas of the portions where openings are not provided, in a plan view in the Z1 direction. Therefore, according to Comparative Example W2, the stiffness of the flat plate portion 51-W2 can be increased, compared with Comparative Example W1.

However, in Comparative Example W2, the multilayer structure 55-W2 is interposed between the flat plate portion 51-W2 and the lower holder 131-W2. Therefore, according to Comparative Example W2, there is a problem in that the positioning accuracy of the head chips 12 with respect to the flat plate portion 51-W2 cannot be increased, compared with Comparative Example W1.

In contrast, in the present embodiment, the flat plate portion 51 is in direct contact with the protruding portions 131T included in the lower holder 131. For this reason, according to the present embodiment, it is possible to increase the positioning accuracy of the head chips 12 with respect to the flat plate portion 51, compared with Comparative Example W2. As described above, according to the present embodiment, it is easy to ensure both the stiffness of the flat plate portion 51 and the positioning accuracy of the head chips 12 with respect to the flat plate portion 51, compared with Comparative Example W1 and Comparative Example W2.

### A.4.3. Modifications

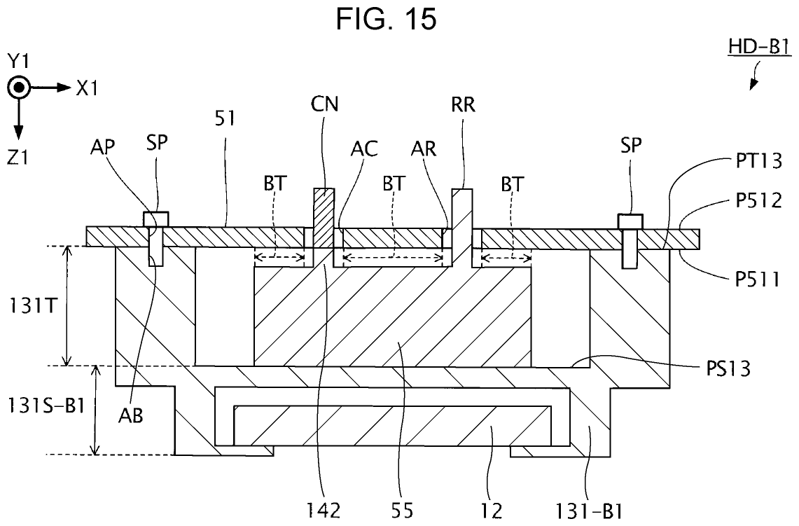

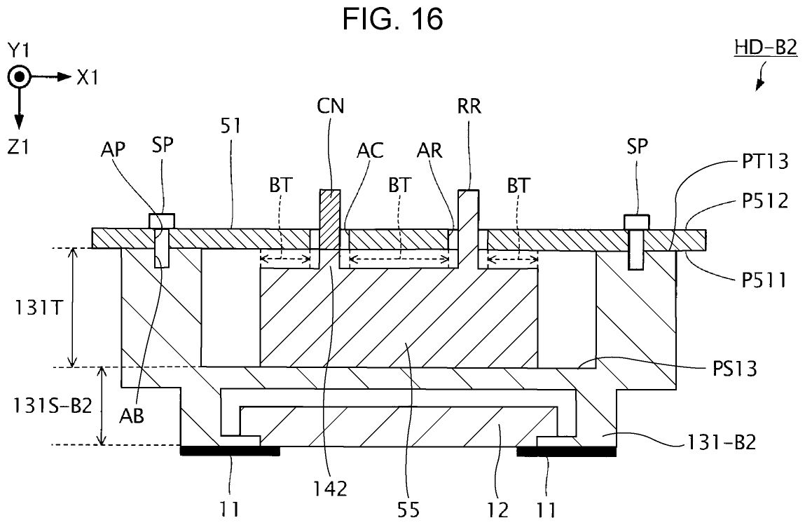

Hereinafter, regarding the head unit HD according to the present embodiment, Modification B1 and Modification B2 in which the lower holder 131 has another configuration will be described with reference to FIGS. 15 and 16.

FIG. 15 is a schematic diagram illustrating a cross section of a head unit HD-B1 according to Modification B1.

As illustrated in FIG. 15, the head unit HD-B1 according to Modification B1 is different from the head unit HD according to the present embodiment in that the head unit HD-B1 includes a lower holder 131-B1 instead of the lower holder 131 and does not include the fixing plate 11. The lower holder 131-B1 is different from the lower holder 131 according to the present embodiment in that the lower holder 131-B1 includes a housing portion 131S-B1 instead of the housing portion 131S. The housing portion 131S-B1 has a shape in which the housing portion 131S and the fixing plate 11 are combined. In Modification B1, the plurality of head chips 12 are fixed to the housing portion 131S-B1 in a state of being in alignment with one another.

According to Modification B1, similarly to the present embodiment, it is easy to secure both the stiffness of the flat plate portion 51 and the positioning accuracy of the head chips 12 with respect to the flat plate portion 51. In addition, according to Modification B1, since the head unit HD-B1 does not include the fixing plate 11, it is possible to reduce the number of components of the head unit HD-B1.

FIG. 16 is a schematic diagram illustrating a cross section of a head unit HD-B2 according to Modification B2.

As illustrated in FIG. 16, the head unit HD-B2 according to Modification B2 is different from the head unit HD according to the present embodiment in that the head unit HD-B2 has a lower holder 131-B2 instead of the lower holder 131. The lower holder 131-B2 is different from the lower holder 131 according to the present embodiment in that the lower holder 131-B2 has a housing portion 131S-B2 instead of the housing portion 131S. The housing portion 131S-B2 is different from the housing portion 131S according to the present embodiment in that the plurality of head chips 12 are fixed in a state of being in alignment with one another.

The example illustrated in FIG. 16 is based on an example of a configuration in which the head chips 12 are fixed to both the fixing plate 11 and the housing portion 131S-B2, but Modification B2 is not limited to such a configuration. The head chips 12 may be fixed only to the housing portion 131S-B2. In that case, the fixing plate 11 may be fixed only to the housing portion 131S-B2.

According to Modification B2, similarly to the present embodiment, it is easy to secure both the stiffness of the flat plate portion 51 and the positioning accuracy of the head chips 12 with respect to the flat plate portion 51.

### A.5. Relay Substrate 14

Hereinafter, the relay substrate 14 will be described with reference to FIG. 17.

FIG. 17 is a perspective view of a configuration including the relay substrate 14, the lower holder 131, the intermediate holder 132, and the upper holders 133.

As illustrated in FIG. 17, the relay substrate 14 is provided with drive-line connection connectors 141[1] to 141[4] corresponding to the four wiring circuit boards 120[1] to 120[4] and the B-to-B connector 142 corresponding to the B-to-B connector CN, on the upper surface of the relay substrate 14. The wiring circuit board 120[j] is connected to the drive-line connection connector 141[j]. The B-to-B connector CN is connected to the B-to-B connector 142.

As illustrated in FIG. 17, in a plan view of the relay substrate 14 in the Z1 direction, the B-to-B connector 142 is disposed in a region including a position between the drive-line connection connector 141[1] and the drive-line connection connector 141[2] and a position between the drive-line connection connector 141[3] and the drive-line connection connector 141[4] in the X-axis direction and is disposed in a region between a set of the drive-line connection connector 141[1] and the drive-line connection connector 141[2] and a set of the drive-line connection connector 141[3] and the drive-line connection connector 141[4] in the Y-axis direction. That is, in a plan view of the relay substrate 14 in the Z1 direction, the B-to-B connector 142 is disposed inside the four drive-line connection connectors 141[1] to 141[4]. To be more specific, in a plan view of the relay substrate 14 in the Z1 direction, the B-to-B connector 142 may be disposed in a central portion or at the center of the four drive-line connection connectors 141[1] to 141[4].

In addition, the drive-line connection connector 141[j] and the B-to-B connector 142 are electrically connected with wiring (not illustrated). Therefore, the relay substrate 14 electrically connects the wiring circuit board 120[j] connected to the drive-line connection connector 141[j] and the B-to-B connector CN connected to the B-to-B connector 142.

As described above, according to the present embodiment, since the B-to-B connector 142 is disposed in a central portion of the four drive-line connection connectors 141[1] to 141[4], it is possible to shorten the path length of the wiring between the B-to-B connector 142 and each drive-line connection connector 141[j], compared with, for example, a configuration in which the B-to-B connector 142 is disposed outside the four drive-line connection connectors 141[1] to 141[4]. For this reason, according to the present embodiment, it is possible to reduce the possibility that noise is superimposed on a signal flowing through the wiring provided on the relay substrate 14.

### A.6. Supply Flow Paths Q

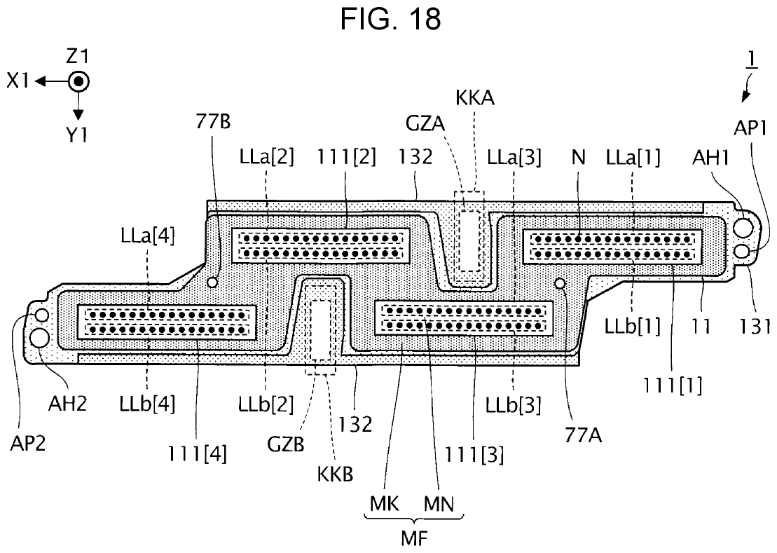

Hereinafter, the supply flow paths Q will be described with reference to FIGS. 18 to 28.

### A.6.1. Outline of Supply Flow Paths Q

First, an outline of the nozzles N to which ink is supplied from the supply flow paths Q and an outline of the supply flow paths Q will be described with reference to FIGS. 18 to 21.

FIG. 18 is a plan view of the liquid ejecting head 1 viewed in the Z2 direction.

As illustrated in FIG. 18, the liquid ejecting head 1 has a plurality of nozzle rows LL. Here, a nozzle row LL is composed of a set of nozzles N. In the present embodiment, it is assumed that a nozzle row LL includes a predetermined number of nozzles N aligned in the X-axis direction. In addition, in the present embodiment, it is assumed that each of the four head chips 12[1] to 12[4] provided in the liquid ejecting head 1 has two nozzle rows LL. That is, in the present embodiment, it is assumed that eight nozzle rows LL are provided in the liquid ejecting head 1.

Hereinafter, the two nozzle rows LL provided in the head chip 12[j] are referred to as the nozzle row LLa[j] and the nozzle row LLb[j]. When the liquid ejecting head 1 is viewed in the Z2 direction, the nozzle row LLa[j] and the nozzle row LLb[j] are arranged so as to be exposed in the Z1 direction from the nozzle exposure opening 111[j]. In addition, the nozzle row LLb[j] is provided in the Y1 direction when viewed from the nozzle row LLa[j].

As illustrated in FIG. 18, in a plan view of the liquid ejecting head 1 in the Z2 direction, the surface of the head chip 12 on which the nozzle rows LL are formed is referred to as the nozzle forming surface MN. The lower surface of the fixing plate 11 is referred to as the medium facing surface MK. The ejection surface MF is a surface including the nozzle forming surface MN and the medium facing surface MK.

In addition, as illustrated in FIG. 18, in a plan view of the liquid ejecting head 1 in the Z2 direction, the cutout portion KKA is provided between the nozzle exposure opening 111[1] and the nozzle exposure opening 111[2]. A medium pressing mechanism GZA is disposed in the cutout portion KKA. The medium pressing mechanism GZA is a component for preventing the media PP being transported in the Y1 direction by the transport mechanism 91 from deviating from the transport path of the medium PP. In detail, the medium pressing mechanism GZA prevents the medium PP from deviating from the transport path by pressing the medium PP in the Z1 direction.

In addition, in a plan view of the liquid ejecting head 1 in the Z2 direction, the cutout portion KKB is provided between the nozzle exposure opening 111[3] and the nozzle exposure opening 111[4]. A medium pressing mechanism GZB is disposed in the cutout portion KKB. The medium pressing mechanism GZB has the same or a similar configuration as the medium pressing mechanism GZA, and prevents the medium PP being transported in the Y1 direction by the transport mechanism 91 from deviating from the transport path of the medium PP. Hereinafter, the medium pressing mechanism GZA and the medium pressing mechanism GZB may be collectively referred to as the medium pressing mechanisms GZ.

Further, as illustrated in FIG. 18, the fixing plate 11 is provided with two fixing plate openings 77 including a fixing plate opening 77A and a fixing plate opening 77B. Of these, the fixing plate opening 77A is provided between the nozzle exposure opening 111[1] and the nozzle exposure opening 111[3]. In addition, the fixing plate opening 77B is provided between the nozzle exposure opening 111[2] and the nozzle exposure opening 111[4].

The fixing plate openings 77 are openings into which positioning pins provided in a jig (not illustrated) are inserted when the head chips 12 are fixed to the fixing plate 11 in the manufacturing process of the head unit HD. When the head chips 12 are fixed to the fixing plate 11, the fixing plate 11 is positioned with respect to the jig by inserting the positioning pins of the jig into the fixing plate openings 77. By fixing the head chips 12 to the fixing plate 11 in a state in which the positioning pins of the jig are inserted into the fixing plate openings 77, it is possible to accurately position the plurality of head chips 12 with respect to the fixing plate 11.

FIG. 19 is a schematic diagram illustrating the relationship between the four supply flow paths Q(1) to Q(4) provided in the liquid ejecting head 1 and the eight nozzle rows LL provided in the liquid ejecting head 1.

As illustrated in FIG. 19, four systems of supply flow paths Q, namely, the supply flow paths Q(1) to Q(4), are provided in the liquid ejecting head 1. In addition, four filter chambers FT(1) to FT(4) corresponding to the four systems of supply flow paths Q(1) to Q(4) are provided in the liquid ejecting head 1. The supply flow path Q(u) communicates with the filter chamber FT(u). Hereinafter, the connection flow path RR which communicates with the filter chamber FT(u) may be referred to as the connection flow path RR(u). Ink is supplied to the filter chamber FT(u) from the flow path provided in the common flow path member 41 via the connection flow path RR(u).

As illustrated in FIG. 19, the supply flow path Q(1) supplies the ink supplied from the connection flow path RR(1) via the filter chamber FT(1) to the nozzle row LLa[1] and the nozzle row LLa[2].

The supply flow path Q(2) supplies the ink supplied from the connection flow path RR(2) via the filter chamber FT(2) to the nozzle row LLb[1] and the nozzle row LLb[2].

The supply flow path Q(3) supplies the ink supplied from the connection flow path RR(3) via the filter chamber FT(3) to the nozzle row LLa[3] and the nozzle row LLa[4].

The supply flow path Q(4) supplies the ink supplied from the connection flow path RR(4) via the filter chamber FT(4) to the nozzle row LLb[3] and the nozzle row LLb[4].

FIG. 20 is a schematic diagram for explaining the configuration of a supply flow path Q. Note that FIG. 20 illustrates the supply flow path Q(1) as an example.

As illustrated in FIG. 20, the supply flow path Q includes an introduction flow path Q0, a distribution flow path Q1, and a distribution flow path Q2.

The introduction flow path Q0 is a flow path for supplying the ink introduced from the filter chamber FT(1) to a branch position GB. To be specific, the introduction flow path Q0 is a flow path that extends in the Z1 direction in an upper holder 133 and reaches the branch position GB. Here, the branch position GB is a position at which the introduction flow path Q0 branches into the distribution flow path Q1 and the distribution flow path Q2.

The distribution flow path Q1 is a flow path located downstream of the branch position GB and for supplying the ink introduced from the introduction flow path Q0 to the branch position GB, to the nozzle row LLa[1]. To be specific, the distribution flow path Q1 connects the introduction flow path Q0 and the head chip 12[1]. To be more specific, the distribution flow path Q1 communicates with the introduction flow path Q0 at the branch position GB, and communicates with an in-chip flow path which is provided in the head chip 12[1] and is for supplying ink to the nozzle row LLa[1].

As illustrated in FIG. 20, the distribution flow path Q1 includes a portion extending in the Z1 direction from the branch position GB in the intermediate holder 132 and the lower holder 131, and a portion extending in the X2 direction between the lower holder 131 and the intermediate holder 132.

Hereinafter, in the introduction flow path Q0 and the distribution flow path Q1, a portion extending in the Z1 direction in the upper holder 133, the intermediate holder 132, and the lower holder 131 may be referred to as the extension flow path QR1.

In addition, hereinafter, a portion of the distribution flow path Q1 extending in the X2 direction between the lower holder 131 and the intermediate holder 132 may be referred to as the individual flow path QK1. That is, the individual flow path QK1 is a flow path which is connected to the end portion of the extension flow path QR1 in the Z1 direction, extends in the X2 direction, and individually communicates with the nozzle row LLa[1].

The distribution flow path Q2 is a flow path located downstream of the branch position GB and for supplying the ink introduced from the introduction flow path Q0 to the branch position GB, to the nozzle row LLa[2]. To be specific, the distribution flow path Q2 connects the introduction flow path Q0 and the head chip 12[2]. To be more specific, the distribution flow path Q2 communicates with the introduction flow path Q0 at the branch position GB, and communicates with an in-chip flow path which is provided in the head chip 12[2] and is for supplying ink to the nozzle row LLa[2].

As illustrated in FIG. 20, the distribution flow path Q2 includes a portion extending in the X1 direction between the upper holder 133 and the intermediate holder 132, a portion extending in the Z1 direction in the intermediate holder 132, and a portion extending in the X1 direction between the lower holder 131 and the intermediate holder 132.

Hereinafter, a portion of the distribution flow path Q2 extending in the X1 direction between the upper holder 133 and the intermediate holder 132 may be referred to as the individual flow path QK2. That is, the individual flow path QK2 is a flow path which is connected to the extension flow path QR1 at the branch position GB, extends in the X1 direction, and individually communicates with the nozzle row LLa[2].

In addition, hereinafter, a portion of the distribution flow path Q2 extending in the X1 direction between the lower holder 131 and the intermediate holder 132 may be referred to as the extension flow path QR2.

As illustrated in FIG. 20, the lower holder 131 is provided with a cutout portion KK at a position which is between the individual flow path QK1 and the extension flow path QR2 and overlaps the individual flow path QK2 in a plan view in the Z1 direction. In addition, the intermediate holder 132 is provided with a recessed portion 132u which is recessed in the Z2 direction at a position which overlaps the individual flow path QK2 in a plan view in the Z1 direction and which overlaps the cutout portion KK.

As described above, according to the present embodiment, since the recessed portion 132u is provided on the upper side of the cutout portion KK, it is possible to secure a sufficient space for disposing the medium pressing mechanism GZ.

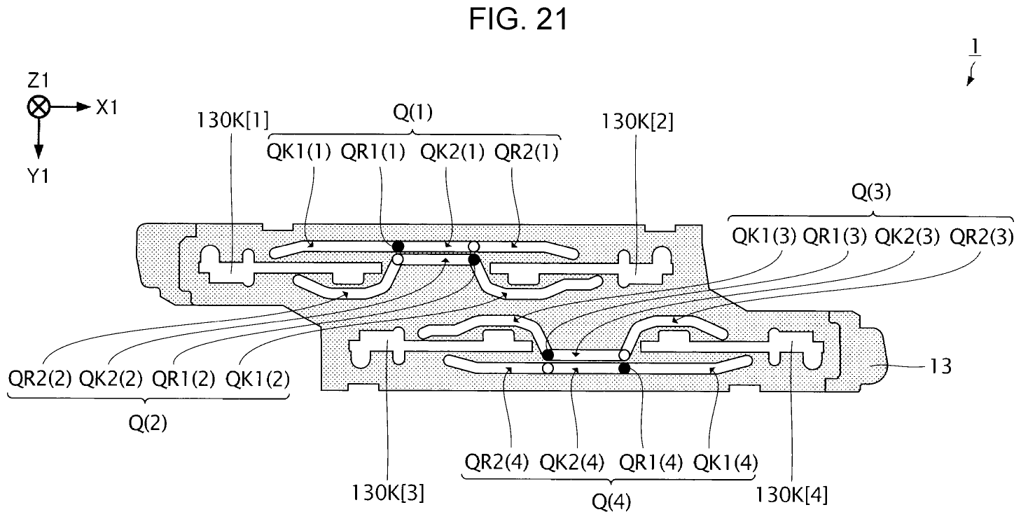

In addition, in the present embodiment, as illustrated in FIG. 21 which will be described later, the shape of the supply flow path Q is determined such that the flow path length of the individual flow path QK2 is shorter than the flow path length of the individual flow path QK1 and is shorter than the flow path length of the extension flow path QR2. In the present embodiment, the shape of the holder 13 is determined such that, in a plan view in the Z1 direction, the areas inside the outer peripheries of the upper holders 133 are smaller than the area inside the outer periphery of the lower holder 131 and are smaller than the area inside the outer periphery of the intermediate holder 132. Here, “the area inside the outer periphery of one object in a plan view in the Z1 direction” is defined as the total area of the area of the one object and the areas of the openings provided in the one object in a plan view in the Z1 direction.

As described above, in the present embodiment, the shape of the supply flow path Q is determined such that the flow path length of the individual flow path QK2 is short, and thus it is possible to reduce the area of the upper holder 133 which defines the upper side of the individual flow path QK2. For this reason, according to the present embodiment, it is possible to reduce the size of the liquid ejecting head 1 compared with cases where the flow path length of the individual flow path QK2 is longer than the flow path length of the individual flow path QK1 or the flow path length of the extension flow path QR2, and the area of the upper holders 133 in a plan view in the Z1 direction is larger than the area of the lower holder 131 or the area of the intermediate holder 132.

In the present embodiment, in a plan view in the Z1 direction, the introduction flow path Q0 is provided at a position closer to the head chip 12[1] than to the head chip 12[2] in the upper holder 133. For this reason, in the present embodiment, it is possible to provide a portion extending in the Z1 direction from the branch position GB in the distribution flow path Q1. That is, in the present embodiment, the extension flow path QR1 extending in the Z1 direction and having the branch position GB in the middle can be provided in the supply flow path Q.

FIG. 21 is a plan view for explaining the configurations of the holder 13 and the supply flow paths Q(1) to Q(4) in a plan view in the Z1 direction. In the following description, the introduction flow path Q0 corresponding to the supply flow path Q(u) may be referred to as the introduction flow path Q0(u), the extension flow path QR1 corresponding to the supply flow path Q(u) may be referred to as the extension flow path QR1(u), the individual flow path QK1 corresponding to the supply flow path Q(u) may be referred to as the individual flow path QK1(u), the extension flow path QR2 corresponding to the supply flow path Q(u) may be referred to as the extension flow path QR2(u), and the individual flow path QK2 corresponding to the supply flow path Q(u) may be referred to as the individual flow path QK2(u).

As illustrated in FIG. 21, in a plan view in the Z1 direction, the supply flow path Q(1) includes an extension flow path QR1(1), an individual flow path QK1(1) linearly extending from the extension flow path QR1(1) in the X2 direction, an individual flow path QK2(1) linearly extending from the extension flow path QR1(1) in the X1 direction, and an extension flow path QR2(1) linearly extending in the X1 direction from a position overlapping an end portion of the individual flow path QK2(1) in the X1 direction.

In addition, in a plan view in the Z1 direction, the supply flow path Q(2) includes an extension flow path QR1(2), an individual flow path QK1(2) curvedly extending from the extension flow path QR1(2) in the X1 direction so as to avoid the wiring opening 130K[2], an individual flow path QK2(2) linearly extending from the extension flow path QR1(2) in the X2 direction, and an extension flow path QR2(2) curvedly extending in the X2 direction from the position overlapping the end portion of the individual flow path QK2(2) in the X2 direction so as to avoid the wiring opening 130K[1].

In addition, in a plan view in the Z1 direction, the supply flow path Q(3) includes an extension flow path QR1(3), an individual flow path QK1(3) curvedly extending from the extension flow path QR1(3) in the X2 direction so as to avoid the wiring opening 130K[3], an individual flow path QK2(3) linearly extending from the extension flow path QR1(3) in the X1 direction, and an extension flow path QR2(3) curvedly extending in the X1 direction from the position overlapping the end portion of the individual flow path QK2(3) in the X1 direction so as to avoid the wiring opening 130K[4].

In a plan view in the Z1 direction, the supply flow path Q(4) includes an extension flow path QR1(4), an individual flow path QK1(4) linearly extending from the extension flow path QR1(4) in the X1 direction, an individual flow path QK2(4) linearly extending from the extension flow path QR1(4) in the X2 direction, and an extension flow path QR2(4) linearly extending in the X2 direction from the position overlapping the end portion of the individual flow path QK2(4) in the X2 direction.

As described above, according to the present embodiment, in the supply flow paths Q(2) and Q(3), of the supply flow paths Q(1) to Q(4), which overlap the wiring opening 130K[j] in the Y-axis direction and need to avoid the wiring opening 130K[j], the individual flow path QK1(u) and the extension flow path QR2(u) are formed in curved shapes to avoid the wiring opening 130K[j], and the individual flow path QK2(u) maintains a linear shape.

Therefore, in the present embodiment, the flow path length of the individual flow path QK2(u) can be made shorter than the flow path length of the individual flow path QK1(u) and the flow path length of the extension flow path QR2(u). Thus, in the present embodiment, it is possible to reduce the areas of the upper holders 133 that define the upper side of the individual flow path QK2(u). Therefore, according to the present embodiment, for example, it is possible to reduce the size of the liquid ejecting head 1, compared with configurations in which the individual flow path QK2(u) is formed in a curved shape.

### A.6.2. Comparative Examples

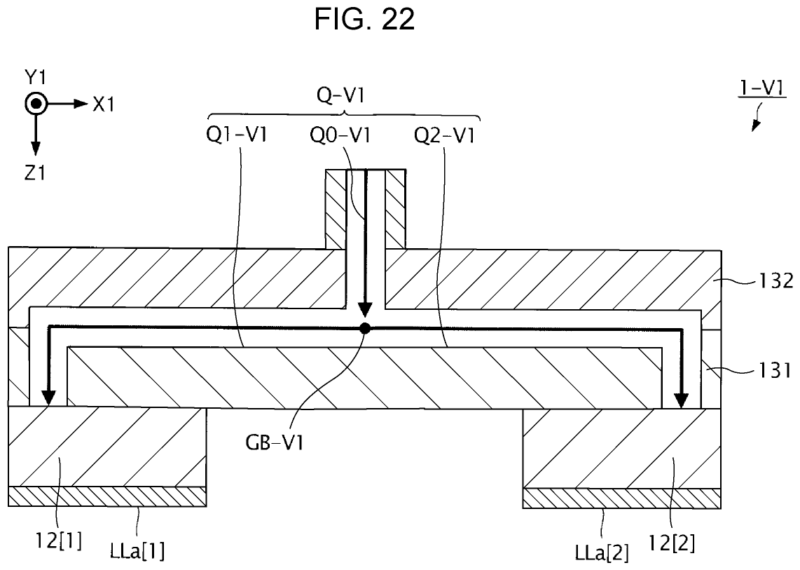

Hereinafter, in order to clarify the advantages of the present embodiment, supply flow paths according to comparative examples and the advantages of the present embodiment will be described with reference to FIGS. 22 to 26.

FIG. 22 is a schematic diagram for explaining the configuration of a supply flow path Q-V1 provided in a liquid ejecting head 1-V1 according to Comparative Example V1.

As illustrated in FIG. 22, the supply flow path Q-V1 includes an introduction flow path Q0-V1, a distribution flow path Q1-V1, and a distribution flow path Q2-V1.

The introduction flow path Q0-V1 is a flow path for supplying the ink introduced from the filter chamber FT(1) to a branch position GB-V1, and is a flow path which extends in the Z1 direction in the intermediate holder 132 and reaches the branch position GB-V1.

The distribution flow path Q1-V1 is a flow path for supplying the ink introduced from the introduction flow path Q0-V1 to the nozzle row LLa[1], is located downstream of the branch position GB-V1, and extends in the X2 direction from the branch position GB-V1 between the lower holder 131 and the intermediate holder 132.

The distribution flow path Q2-V1 is a flow path for supplying the ink introduced from the introduction flow path Q0-V1 to the nozzle row LLa[2], is located downstream of the branch position GB-V1, and extends in the X1 direction from the branch position GB-V1 between the lower holder 131 and the intermediate holder 132.

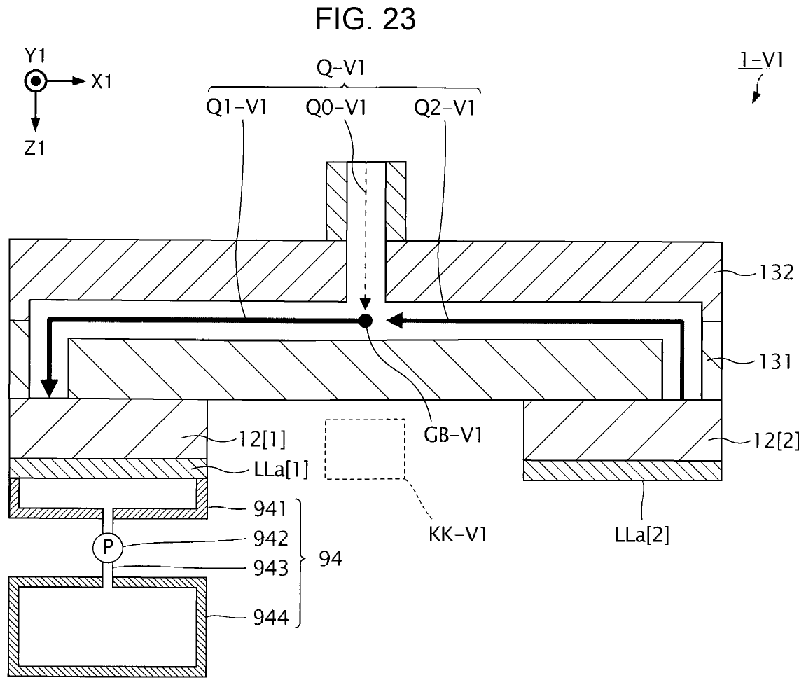

FIG. 23 is a schematic diagram for explaining a suction cleaning process performed on the liquid ejecting head 1-V1 according to Comparative Example V1. The suction cleaning process includes a plurality of suction operations including a first suction operation of sucking ink from the nozzle row LLa[1] and a second suction operation of sucking ink from the nozzle row LLa[2]. FIG. 23 illustrates a state in which the first suction operation is performed in the suction cleaning process.

As illustrated in FIG. 23, the cleaning unit 94 includes a cap 941, a suction pump 942, a discharge pipe 943, and a waste liquid tank 944. When the suction operation for the nozzle row LL is performed, the cap 941 forms a closed space between the cap 941 and the nozzle forming surface MN by sealing the nozzle forming surface MN on which the nozzle row LL is formed in the ejection surface MF. The closed space formed by the cap 941 communicates with the plurality of nozzles N composing the nozzle row LL for the suction operation. The suction pump 942 depressurizes the closed space formed by the cap 941 to suck ink from the nozzles N composing the nozzle row LL. Then, the suction pump 942 discharges the ink sucked from the nozzles N to the waste liquid tank 944 via the discharge pipe 943.

As illustrated in FIG. 23, in the liquid ejecting head 1-V1, when the first suction operation of sucking ink from the nozzle row LLa[1] is performed, a negative pressure is applied to the distribution flow path Q1-V1 from the suction pump 942, and the ink in the distribution flow path Q1-V1 is discharged from the nozzles N composing the nozzle row LLa[1]. Since the distribution flow path Q1-V1 is in communication with the introduction flow path Q0-V1 and the distribution flow path Q2-V1, the negative pressure applied from the suction pump 942 to the distribution flow path Q1-V1 also acts on the introduction flow path Q0-V1 and the distribution flow path Q2-V1 via the distribution flow path Q1-V1.

As described above, at the branch position GB-V1, the distribution flow path Q1-V1 extends in the X1 direction. At the branch position GB-V1, the distribution flow path Q2-V1 extends in the X2 direction. That is, in Comparative Example V1, at the branch position GB-V1, the distribution flow path Q1-V1 and the distribution flow path Q2-V1 are opposed to each other. In addition, at the branch position GB-V1, the introduction flow path Q0-V1 extends in the Z1 direction. That is, in Comparative Example V1, the distribution flow path Q1-V1 intersects the introduction flow path Q0-V1 at the branch position GB-V1.

Therefore, in Comparative Example V1, the negative pressure applied from the suction pump 942 to the distribution flow path Q1-V1 acts relatively strongly on the distribution flow path Q2-V1 which is opposed to the distribution flow path Q1-V1 at the branch position GB-V1 and extends in the same direction as the extending direction of the distribution flow path Q1-V1, and acts relatively weakly on the introduction flow path Q0-V1 which intersects with the distribution flow path Q1-V1 at the branch position GB-V1 and extends in a direction different from the extending direction of the distribution flow path Q1-V1. Therefore, while the ink in the distribution flow path Q2-V1 is easily discharged from the nozzle row LLa[1] via the distribution flow path Q1-V1 by the negative pressure applied to the distribution flow path Q1-V1 from the suction pump 942, the ink in the introduction flow path Q0-V1 is highly likely not to be sufficiently discharged from the nozzle row LLa[1]. For this reason, according to Comparative Example V1, there is a case where the air bubbles retained in the filter chamber FT(1) which communicates with the introduction flow path Q0-V1 cannot be sufficiently discharged.

In the liquid ejecting head 1-V1, when the second suction operation of sucking ink from the nozzle row LLa[2] is performed, the negative pressure applied from the suction pump 942 to the distribution flow path Q2-V1 acts relatively strongly on the distribution flow path Q1-V1 which is opposed to the distribution flow path Q2-V1 at the branch position GB-V1 and extends in the same direction as the extending direction of the distribution flow path Q2-V1, and acts relatively weakly on the introduction flow path Q0-V1 which intersect the distribution flow path Q2-V1 at the branch position GB-V1 and extends in a direction different from the extending direction of the distribution flow path Q2-V1. Therefore, according to Comparative Example V1, also in the second suction operation, the ink in the distribution flow path Q1-V1 is likely to be discharged from the nozzle row LLa[2] via the distribution flow path Q2-V1 by the negative pressure applied from the suction pump 942 to the distribution flow path Q2-V1, but the ink in the introduction flow path Q0-V1 is likely not to be sufficiently discharged from the nozzle row LLa[2]. For this reason, according to Comparative Example V1, also in the second suction operation, there is a case where the air bubbles retained in the filter chamber FT(1) which communicates with the introduction flow path Q0-V1 cannot be sufficiently discharged.

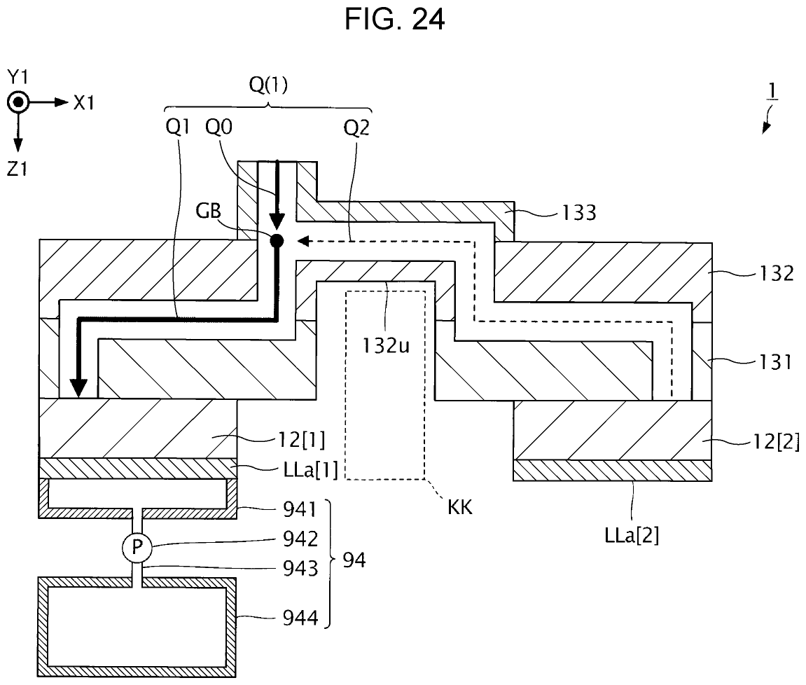

FIG. 24 is a schematic diagram for explaining the suction cleaning process performed on the liquid ejecting head 1 according to the present embodiment. FIG. 24 illustrates a state in which the first suction operation for the nozzle row LLa[1] is performed in the suction cleaning process.

As illustrated in FIG. 24, in the liquid ejecting head 1, when the first suction operation of sucking the ink from the nozzle row LLa[1] is performed, a negative pressure is applied to the distribution flow path Q1 from the suction pump 942, and the ink in the distribution flow path Q1 is discharged from the nozzles N composing the nozzle row LLa[1]. Since the distribution flow path Q1 communicates with the introduction flow path Q0 and the distribution flow path Q2, the negative pressure applied from the suction pump 942 to the distribution flow path Q1 also acts on the introduction flow path Q0 and the distribution flow path Q2 via the distribution flow path Q1.

As described above, the distribution flow path Q1 extends in the Z1 direction at the branch position GB. At the branch position GB, the distribution flow path Q2 extends in the X1 direction. That is, in the present embodiment, the distribution flow path Q1 intersects the distribution flow path Q2 at the branch position GB. In addition, the introduction flow path Q0 extends in the Z1 direction at the branch position GB. That is, in the present embodiment, the distribution flow path Q1 is opposed to the introduction flow path Q0 at the branch position GB.

Therefore, in the present embodiment, the negative pressure applied to the distribution flow path Q1 from the suction pump 942 acts relatively strongly on the introduction flow path Q0 opposed to the distribution flow path Q1 at the branch position GB and extending in the same direction as the extending direction of the distribution flow path Q1, and acts relatively weakly on the distribution flow path Q2 intersecting the distribution flow path Q1 at the branch position GB and extending in a direction different from the extending direction of the distribution flow path Q1. Therefore, the ink in the distribution flow path Q2 is not easily discharged from the nozzle row LLa[1] via the distribution flow path Q1 by the negative pressure applied to the distribution flow path Q1 from the suction pump 942, whereas the ink in the introduction flow path Q0 is easily discharged from the nozzle row LLa[1]. For this reason, according to the present embodiment, compared with Comparative Example V1, it is possible to effectively discharge the air bubbles retained in the filter chamber FT(1) which communicates with the introduction flow path Q0.

In the liquid ejecting head 1, when the second suction operation of sucking ink from the nozzle row LLa[2] is performed, the negative pressure applied to the distribution flow path Q2 from the suction pump 942 acts relatively weakly on the introduction flow path Q0 intersecting with the distribution flow path Q2 at the branch position GB and extending in a direction different from the extending direction of the distribution flow path Q2, compared with the first suction operation. Therefore, according to the present embodiment, there is a high possibility that the ink in the introduction flow path Q0 is not sufficiently discharged from the nozzle row LLa[2] by the negative pressure applied to the distribution flow path Q2 from the suction pump 942 in the second suction operation. However, according to the present embodiment, since the air bubbles retained in the filter chamber FT(1) communicating with the introduction flow path Q0 are sufficiently discharged in the first suction operation, even though the suction of air bubbles from the filter chamber FT(1) is insufficient in the second suction operation, the air bubbles in the filter chamber FT(1) can be sufficiently discharged as the entire suction cleaning process.

As illustrated in FIG. 23, according to Comparative Example V1, the distribution flow path Q1-V1 and the distribution flow path Q2-V1 are provided between the lower holder 131 and the intermediate holder 132. Therefore, according to Comparative Example V1, the cutout portion KK cannot be provided in the lower holder 131. Therefore, according to Comparative Example V1, it is difficult to secure a sufficient space for disposing the medium pressing mechanism GZ in the liquid ejecting head 1-V1. Therefore, according to Comparative Example V1, it is necessary to provide a space for the medium pressing mechanism GZ, separately from the space in which the liquid ejecting head 1-V1 is disposed, and there is a possibility that the liquid ejecting apparatus is increased in size.

In contrast, according to the present embodiment, since the distribution flow path Q2 includes the individual flow path QK2 defined by the intermediate holder 132 and the upper holder 133, it is possible to provide the cutout portion KK in the lower holder 131 and to provide the recessed portion 132u in the intermediate holder 132. Therefore, according to the present embodiment, it is possible to secure a space for disposing the medium pressing mechanism GZ in the space in which the liquid ejecting head 1 is disposed. Therefore, according to the present embodiment, it is possible to reduce the size of the liquid ejecting apparatus 100, compared with Comparative Example V1.

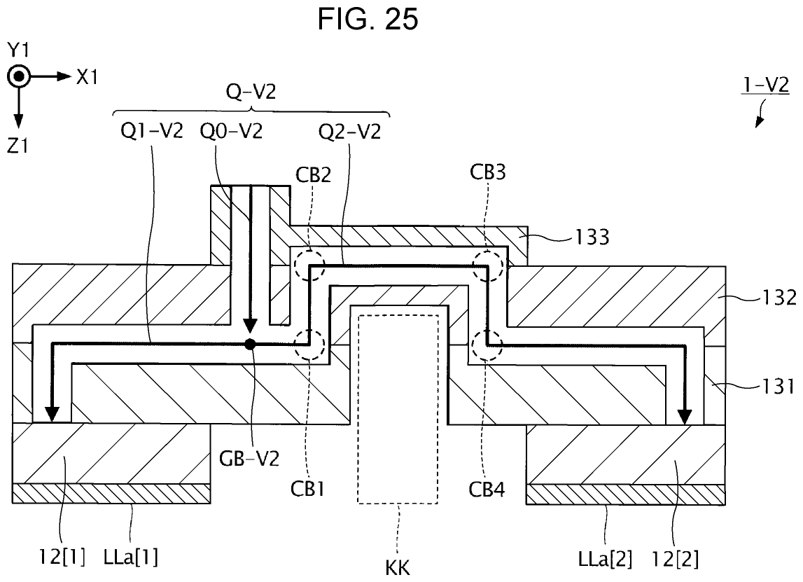

FIG. 25 is a schematic diagram for explaining the configuration of a supply flow path Q-V2 provided in a liquid ejecting head 1-V2 according to Comparative Example V2.

As illustrated in FIG. 25, the supply flow path Q-V2 includes an introduction flow path Q0-V2, a distribution flow path Q1-V2, and a distribution flow path Q2-V2.

The introduction flow path Q0-V2 is a flow path for supplying the ink introduced from the filter chamber FT(1) to a branch position GB-V2, and is a flow path which extends in the Z1 direction in an upper holder 133 and the intermediate holder 132 and reaches the branch position GB-V2.

The distribution flow path Q1-V2 is a flow path for supplying the ink introduced from the introduction flow path Q0-V2 to the nozzle row LLa[1], is located downstream of the branch position GB-V2, and extends in the X2 direction from the branch position GB-V2 between the lower holder 131 and the intermediate holder 132.

The distribution flow path Q2-V2 is a flow path for supplying the ink introduced from the introduction flow path Q0-V2 to the nozzle row LLa[2] and is located downstream of the branch position GB-V2. The distribution flow path Q2-V2 includes a portion extending in the X1 direction from the branch position GB-V2 to a bent portion CB1 between the lower holder 131 and the intermediate holder 132, a portion located downstream of the bent portion CB1 and extending in the Z2 direction to a bent portion CB2 in the intermediate holder 132, a portion located downstream of the bent portion CB2 and extending in the X1 direction to a bent portion CB3 between the upper holder 133 and the intermediate holder 132, a portion located downstream of the bent portion CB3 and extending in the Z1 direction to a bent portion CB4 in the intermediate holder 132, and a portion located downstream of the bent portion CB4 and extending in the X1 direction between the intermediate holder 132 and the lower holder 131.

According to Comparative Example V2, since the distribution flow path Q2-V2 has a portion extending in the X1 direction from the bent portion CB2 to the bent portion CB3 between the upper holder 133 and the intermediate holder 132, it is possible to provide the cutout portion KK in the lower holder 131. Therefore, according to Comparative Example V2, similarly to the present embodiment, it is possible to secure a space for disposing the medium pressing mechanism GZ in the space in which the liquid ejecting head 1-V2 is disposed.

However, according to Comparative Example V2, the distribution flow path Q1-V2 and the distribution flow path Q2-V2 are opposed to each other at the branch position GB-V2, the introduction flow path Q0-V2 and the distribution flow path Q1-V2 intersect each other at the branch position GB-V2, and the introduction flow path Q0-V2 and the distribution flow path Q2-V2 intersect each other at the branch position GB-V2.

Therefore, according to Comparative Example V2, in the first suction operation of sucking ink from the nozzle row LLa[1] in the suction cleaning process performed on the liquid ejecting head 1-V2, the negative pressure applied from the suction pump 942 to the distribution flow path Q1-V2 acts relatively strongly on the distribution flow path Q2-V2 opposed to the distribution flow path Q1-V2, and acts relatively weakly on the introduction flow path Q0-V2 intersecting the distribution flow path Q1-V2. Therefore, according to Comparative Example V2, in the first suction operation, it is not possible to sufficiently discharge the air bubbles retained in the filter chamber FT(1) which communicates with the introduction flow path Q0-V2.

Similarly, according to Comparative Example V2, in the second suction operation of sucking ink from the nozzle row LLa[2] in the suction cleaning process performed on the liquid ejecting head 1-V2, the negative pressure applied from the suction pump 942 to the distribution flow path Q2-V2 acts relatively strongly on the distribution flow path Q1-V2 opposed to the distribution flow path Q2-V2, and acts relatively weakly on the introduction flow path Q0-V2 intersecting the distribution flow path Q2-V2. Therefore, according to Comparative Example V2, in the second suction operation, it is not possible to sufficiently discharge the air bubbles retained in the filter chamber FT(1) which communicates with the introduction flow path Q0-V2.

In this manner, according to Comparative Example V2, in the suction cleaning process which is performed on the liquid ejecting head 1-V2, there is a problem in that the air bubbles retained in the filter chamber FT(1) which communicates with the introduction flow path Q0-V2 cannot be sufficiently discharged.

In contrast, according to the present embodiment, the introduction flow path Q0 and the distribution flow path Q1 are opposed to each other at the branch position GB. Therefore, according to the present embodiment, compared with Comparative Example V2, it is possible to more reliably discharge the air bubbles in the filter chamber FT(1) in the suction cleaning process.

In addition, according to Comparative Example V2, the distribution flow path Q2-V2 includes the four bent portions CB, namely, the bent portion CB1, the bent portion CB2, the bent portion CB3, and the bent portion CB4. Therefore, according to Comparative Example V2, the flow path resistance of the bent portions CB to the ink flowing through the distribution flow path Q2-V2 increases, and the load for supplying ink to the head chip 12[2] via the distribution flow path Q2-V2 increases.

In contrast, according to the present embodiment, the distribution flow path Q2 has only the two bent portions CB, namely, the end portion in the X1 direction of the individual flow path QK2 in the distribution flow path Q2 and the end portion in the X2 direction of the extension flow path QR2 in the distribution flow path Q2. Therefore, according to the present embodiment, compared with Comparative Example V2, it is possible to reduce the flow path resistance of the bent portions CB to the ink flowing in the distribution flow path Q2, and it is possible to reduce the load for supplying ink to the head chip 12[2] via the distribution flow path Q2.

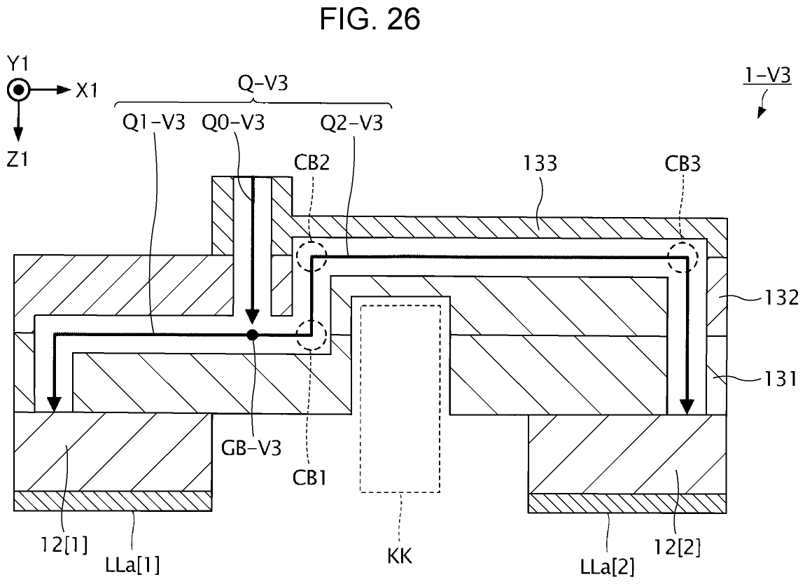

FIG. 26 is a schematic diagram for explaining the configuration of a supply flow path Q-V3 provided in a liquid ejecting head 1-V3 according to Comparative Example V3.

As illustrated in FIG. 26, the supply flow path Q-V3 includes an introduction flow path Q0-V3, a distribution flow path Q1-V3, and a distribution flow path Q2-V3.

The introduction flow path Q0-V3 is a flow path for supplying the ink introduced from the filter chamber FT(1) to a branch position GB-V3, and is a flow path which extends in the Z1 direction in an upper holder 133 and the intermediate holder 132 and reaches the branch position GB-V3.

The distribution flow path Q1-V3 is a flow path for supplying the ink introduced from the introduction flow path Q0-V3 to the nozzle row LLa[1], is located downstream of the branch position GB-V3, and extends in the X2 direction from the branch position GB-V3 between the lower holder 131 and the intermediate holder 132.

The distribution flow path Q2-V3 is a flow path for supplying the ink introduced from the introduction flow path Q0-V3 to the nozzle row LLa[2] and is located downstream of the branch position GB-V3. The distribution flow path Q2-V3 includes a portion extending from the branch position GB-V3 in the X1 direction to a bent portion CB1 between the lower holder 131 and the intermediate holder 132, a portion located downstream of the bent portion CB1 and extending in the Z2 direction to a bent portion CB2 in the intermediate holder 132, and a portion located downstream of the bent portion CB2 and extending in the X1 direction to a bent portion CB3 between the upper holder 133 and the intermediate holder 132.

According to Comparative Example V3, since the distribution flow path Q2-V3 has a portion extending in the X1 direction from the bent portion CB2 to the bent portion CB3 between the upper holder 133 and the intermediate holder 132, it is possible to provide the cutout portion KK in the lower holder 131. Therefore, according to Comparative Example V3, similarly to the present embodiment, it is possible to secure a space for disposing the medium pressing mechanism GZ in the space in which the liquid ejecting head 1-V3 is disposed.

In addition, according to Comparative Example V3, the distribution flow path Q2-V3 has the three bent portions CB, namely, the bent portion CB1, the bent portion CB2, and the bent portion CB3. Therefore, according to Comparative Example V3, similarly to the present embodiment, it is possible to reduce the flow path resistance of the bent portions CB to the ink flowing through the distribution flow path Q2-V3, and to reduce the load for supplying the ink to the head chip 12[2] via the distribution flow path Q2-V3, compared with Comparative Example V2.

However, according to Comparative Example V3, the distribution flow path Q1-V3 and the distribution flow path Q2-V3 are opposed to each other at the branch position GB-V3, the introduction flow path Q0-V3 and the distribution flow path Q1-V3 intersect each other at the branch position GB-V3, and the introduction flow path Q0-V3 and the distribution flow path Q2-V3 intersect each other at the branch position GB-V3.

For this reason, according to Comparative Example V3, similarly to Comparative Example V2, there is a problem in that the air bubbles retained in the filter chamber FT(1) which communicates with the introduction flow path Q0-V3 cannot be sufficiently discharged in the suction cleaning process which is performed on the liquid ejecting head 1-V3.

In contrast, according to the present embodiment, the introduction flow path Q0 and the distribution flow path Q1 are opposed to each other at the branch position GB. Therefore, according to the present embodiment, compared with Comparative Example V3, it is possible to more reliably discharge the air bubbles in the filter chamber FT(1) in the suction cleaning process.

In addition, according to Comparative Example V3, in the distribution flow path Q2-V3, the flow path extending in the X1 direction from the bent portion CB2 to the bent portion CB3 between the upper holder 133 and the intermediate holder 132 extends to the upper side of the head chip 12[2]. For this reason, according to Comparative Example V3, in the distribution flow path Q2-V3, the flow path extending in the X1 direction from the bent portion CB2 to the bent portion CB3 between the upper holder 133 and the intermediate holder 132 is longer than the flow path length of the individual flow path QK2 in the present embodiment. Therefore, according to Comparative Example V3, there is a possibility that the upper holder 133 increases in size, and thus the liquid ejecting head 1-V3 also increases in size.

In contrast, according to the present embodiment, the distribution flow path Q2 is provided such that the individual flow path QK2 is shorter than the extension flow path QR2. For this reason, according to the present embodiment, it is possible to reduce the size of the upper holder 133, compared with Comparative Example V3, and thus it is also possible to suppress an increase in the size of the liquid ejecting head 1.

### A.6.3. Modifications

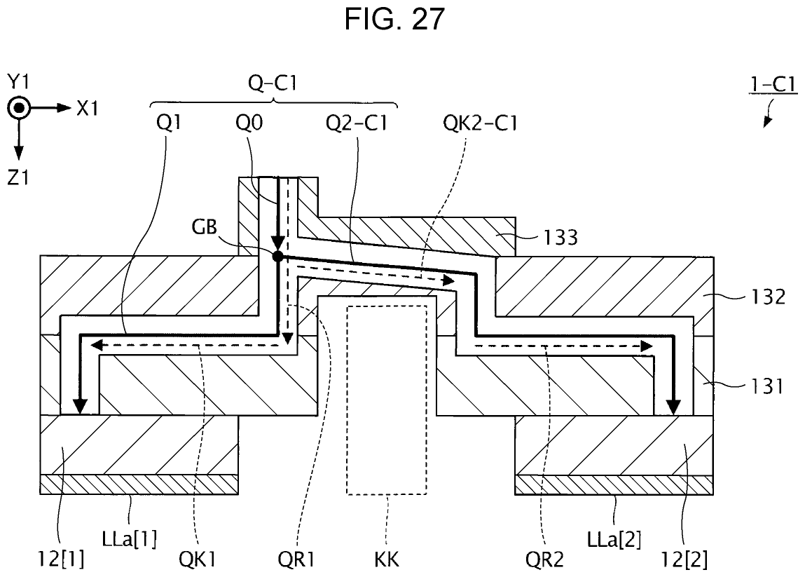

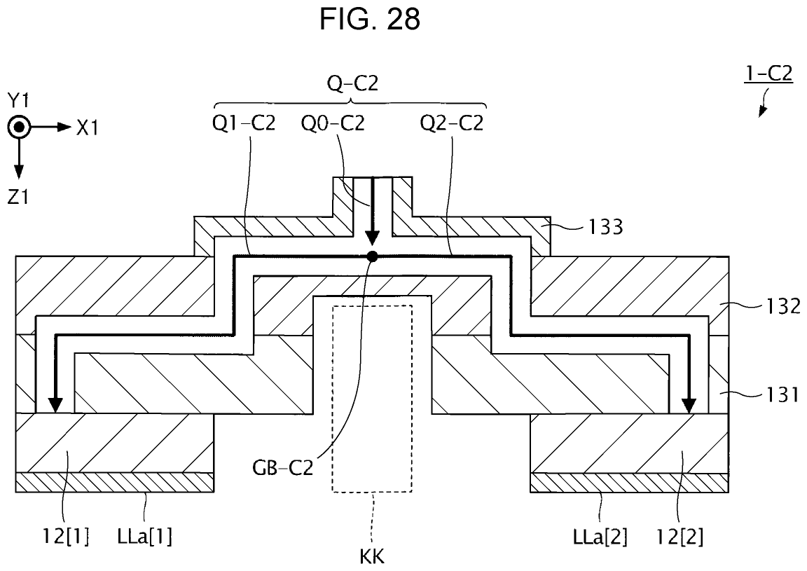

Hereinafter, with reference to FIGS. 27 and 28, Modification C1 and Modification C2 in which the supply flow path Q has another configuration in the liquid ejecting head 1 according to the present embodiment will be described.

FIG. 27 is a schematic diagram for explaining the configuration of a supply flow path Q-C1 provided in a liquid ejecting head 1-C1 according to Modification C1.

As illustrated in FIG. 27, the supply flow path Q-C1 is different from the supply flow path Q according to the present embodiment in that the supply flow path Q-C1 includes a distribution flow path Q2-C1 instead of the distribution flow path Q2. The distribution flow path Q2-C1 is different from the distribution flow path Q2 according to the present embodiment in that the distribution flow path Q2-C1 includes an individual flow path QK2-C1 instead of the individual flow path QK2. The individual flow path QK2-C1 is different from the individual flow path QK2 according to the present embodiment in that the individual flow path QK2-C1 has an inclined portion which is inclined in the Z1 direction as it extends downstream from the branch position GB. In Modification C1, the individual flow path QK2-C1 is defined by an upper holder 133 and the intermediate holder 132, similarly to the individual flow path QK2. The inclined portion may be provided in the entire region of the individual flow path QK2-C1 as illustrated in FIG. 27, or may be provided only in a part of the individual flow path QK2-C1.

For this reason, also in Modification C1, since the cutout portion KK can be provided on the lower side of the individual flow path QK2-C1, similarly to the present embodiment, it is possible to secure a space for disposing the medium pressing mechanism GZ in the space in which the liquid ejecting head 1-C1 is disposed.

In addition, also in Modification C1, the introduction flow path Q0 and the distribution flow path Q1 are opposed to each other at the branch position GB, similarly to the present embodiment. Therefore, according to Modification C1, similarly to the present embodiment, it is possible to more reliably discharge the air bubbles in the filter chamber FT(1) in the suction cleaning process.

FIG. 28 is a schematic diagram for explaining the configuration of a supply flow path Q-C2 provided in a liquid ejecting head 1-C2 according to Modification C2.

As illustrated in FIG. 28, the supply flow path Q-C2 includes an introduction flow path Q0-C2, a distribution flow path Q1-C2, and a distribution flow path Q2-C2.

The introduction flow path Q0-C2 is a flow path for supplying the ink introduced from the filter chamber FT(1) to a branch position GB-C2, and is a flow path which extends in the Z1 direction in an upper holder 133 and the intermediate holder 132 and reaches the branch position GB-C2.

The distribution flow path Q1-C2 is a flow path for supplying the ink introduced from the introduction flow path Q0-C2 to the nozzle row LLa[1], is located downstream of the branch position GB-C2, and includes a portion extending in the X2 direction from the branch position GB-C2 between the upper holder 133 and the intermediate holder 132, a portion extending in the Z1 direction in the intermediate holder 132, and a portion extending in the X2 direction between the lower holder 131 and the intermediate holder 132.

The distribution flow path Q2-C2 is a flow path for supplying the ink introduced from the introduction flow path Q0-C2 to the nozzle row LLa[2], is located downstream of the branch position GB-C2, and includes a portion extending in the X1 direction from the branch position GB-C2 between the upper holder 133 and the intermediate holder 132, a portion extending in the Z1 direction in the intermediate holder 132, and a portion extending in the X1 direction between the lower holder 131 and the intermediate holder 132.

Also in Modification C2, similarly to the present embodiment, since the cutout portion KK can be provided on the lower side of the lower holder 131, it is possible to secure a space for disposing the medium pressing mechanism GZ in the space in which the liquid ejecting head 1-C2 is disposed.

### A.7. Filter Fixing Screws 61 and Nuts 62

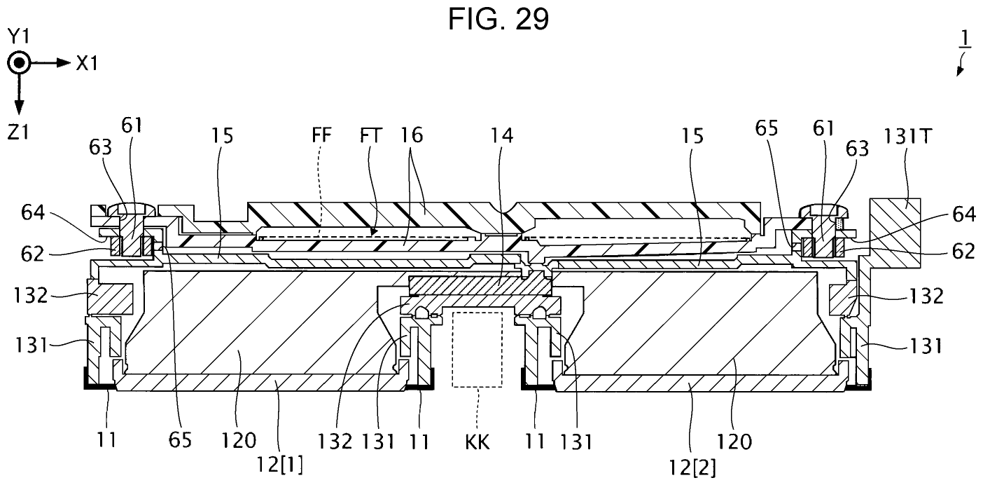

As described above, in the present embodiment, the filter unit 16 is fixed to the substrate cover 15 with the filter fixing screws 61 and the nuts 62. Hereinafter, the fixing of the filter unit 16 to the substrate cover 15 with the filter fixing screws 61 and the nuts 62 will be described with reference to FIGS. 29 to 31.

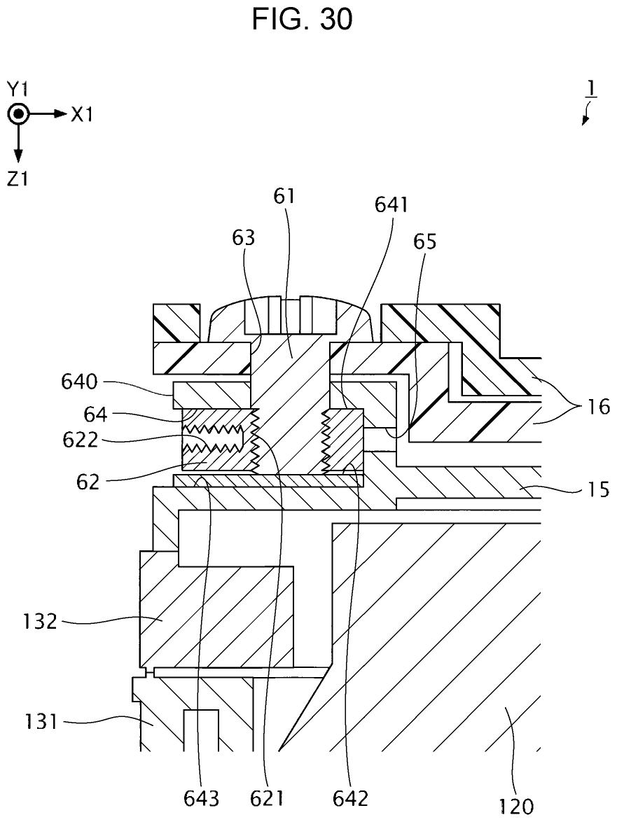

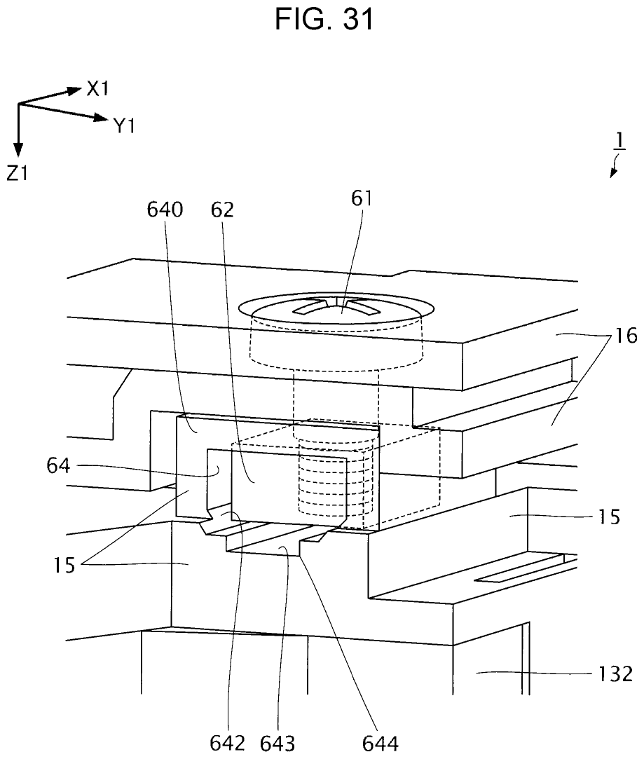

FIG. 29 is a cross-sectional view of the liquid ejecting head 1 taken along a plane having a normal direction parallel to the Y-axis direction so as to include the head chip 12[1] and the head chip 12[2]. FIG. 30 is an enlarged cross-sectional view of the vicinity of a filter fixing screw 61 in FIG. 29. FIG. 31 is a perspective view illustrating the filter fixing screw 61 and its vicinity in FIG. 30.

As illustrated in FIGS. 29 to 31, the substrate cover 15 is provided with housing portions 64.

The housing portion 64 is a recessed portion for housing a nut 62 having a quadrangular prismatic shape, and extends in the X1 direction. To be specific, the housing portion 64 is a recess provided in an end surface 640 which is an end portion of the substrate cover 15 in the X2 direction and which is recessed in the X1 direction.

The nut 62 is made of a metal and press-fitted into the housing portion 64 in the X1 direction. Thus, in the present embodiment, the nut 62 is fixed to the housing portion 64 without using an adhesive. The position in the X-axis direction of the nut 62 press-fitted into the housing portion 64 is defined by the nut 62 coming into contact with an inner end surface 641 which is an end portion of the housing portion 64 in the X1 direction, and the position in the Z-axis direction of the nut 62 is defined by the nut 62 coming into contact with a position defining surface 642 provided above a bottom surface 643 which is an end portion of the housing portion 64 in the Z1 direction.

As illustrated in FIGS. 29 and 30, filter fixing screw holes 63 which extend through the filter unit 16 and the substrate cover 15 in the Z1 direction are provided in the filter unit 16 and the substrate cover 15. The nut 62 is provided with a screw hole 621. When the nut 62 is press-fitted into the housing portion 64, and the nut 62 is positioned by the inner end surface 641 and the position defining surface 642, the filter fixing screw hole 63 provided in the filter unit 16 and the substrate cover 15 and the screw hole 621 provided in the nut 62 are aligned with each other when viewed from the Z1 direction. In addition, the filter fixing screw 61 is inserted into the filter fixing screw hole 63 and the screw hole 621, and thus the substrate cover 15 and the filter unit 16 are fastened.

As illustrated in FIGS. 29 and 30, the substrate cover 15 is provided with a nut push-out opening 65 extending through the inner end surface 641. The area of the nut push-out opening 65 is smaller than the area of the side surface of the nut 62 in contact with the inner end surface 641. A rod (not illustrated) is inserted into the nut push-out opening 65, and the nut 62 press-fitted into the housing portion 64 is pushed in the X2 direction with the rod, whereby the nut 62 can be taken out from the housing portion 64.

As illustrated in FIG. 30, the nut 62 is provided with a screw groove 622 extending in the X1 direction. Since the screw groove 622 is open toward the end surface 640 to which the recessed portion of the housing portion 64 is open, the nut 62 can be taken out from the housing portion 64 by fastening a screw (not illustrated) to the screw groove 622 and pulling the screw in the X2 direction.

As illustrated in FIG. 31, the housing portion 64 is provided with a gap 644 communicating with the screw hole 621 between the nut 62 and the bottom surface 643. An L-shaped rod (not illustrated) having a bent distal end portion is inserted into the gap 644, and the bent portion of the L-shaped rod is hooked into the screw hole 621. In this state, the L-shaped rod is pulled in the X2 direction, whereby the nut 62 can be taken out from the housing portion 64.

As described above, according to the present embodiment, the insertion direction of the filter fixing screw 61 is the Z1 direction, whereas the insertion direction of the nut 62 into the housing portion 64 is the X1 direction. That is, according to the present embodiment, the insertion direction of the filter fixing screw 61 into the nut 62 and the insertion direction of the nut 62 into the housing portion 64 intersect each other. For this reason, according to the present embodiment, when the filter fixing screw 61 is fixed to the nut 62, it is possible to prevent the nut 62 from falling off to the outside of the housing portion 64. Thus, according to the present embodiment, the nut 62 can be fixed to the housing portion 64 without using an adhesive.

Further, according to the present embodiment, since the nut push-out opening 65 communicating with the housing portion 64 is provided in the substrate cover 15, it is possible to easily take out the nut 62 from the housing portion 64. Therefore, according to the present embodiment, for example, compared with configurations in which the insertion direction of the filter fixing screw 61 and the insertion direction of the nut 62 into the housing portion 64 are opposite to each other, it is easy to reuse the nut 62.

### A.8. Fixing between Fixing Plate 11 and Lower Holder 131

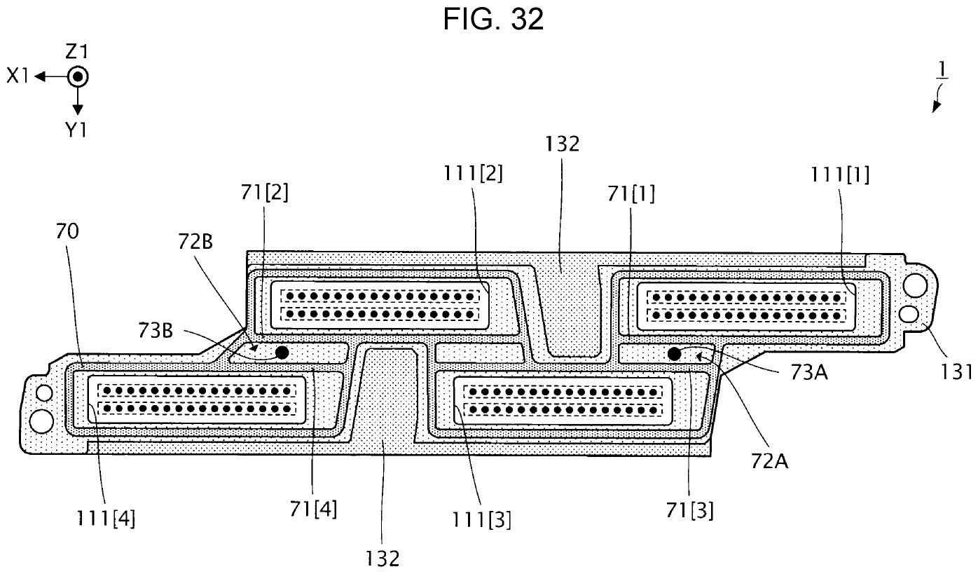

As described above, in the present embodiment, the lower holder 131 is fixed to the fixing plate 11 with an adhesive. Hereinafter, the fixing of the lower holder 131 to the fixing plate 11 will be described with reference to FIGS. 32 to 37.

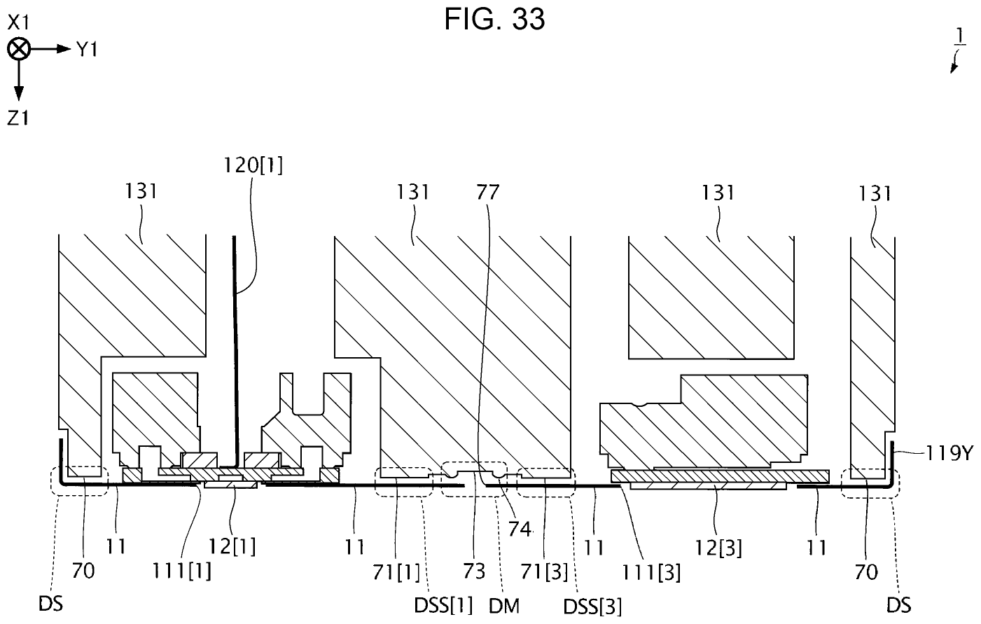

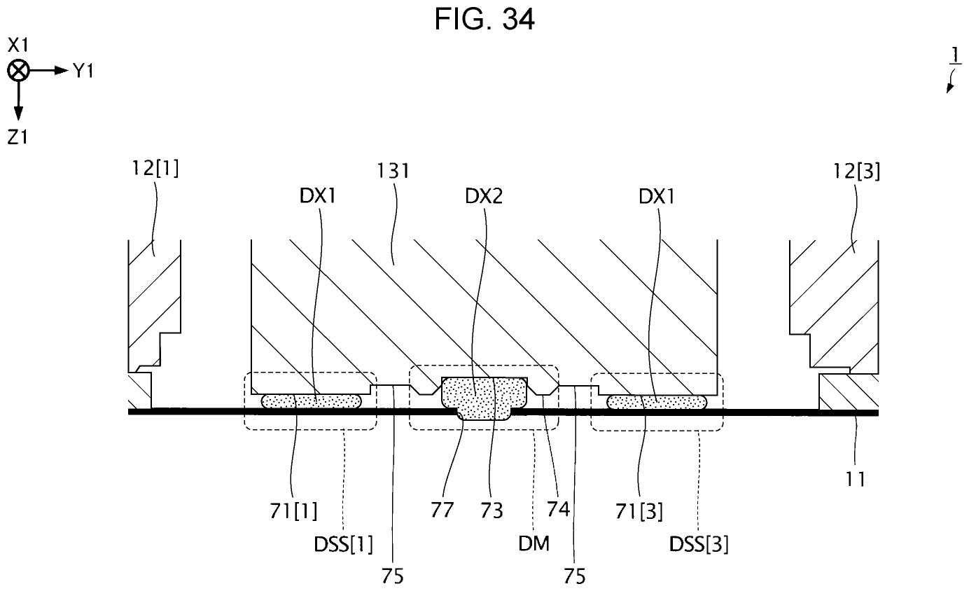

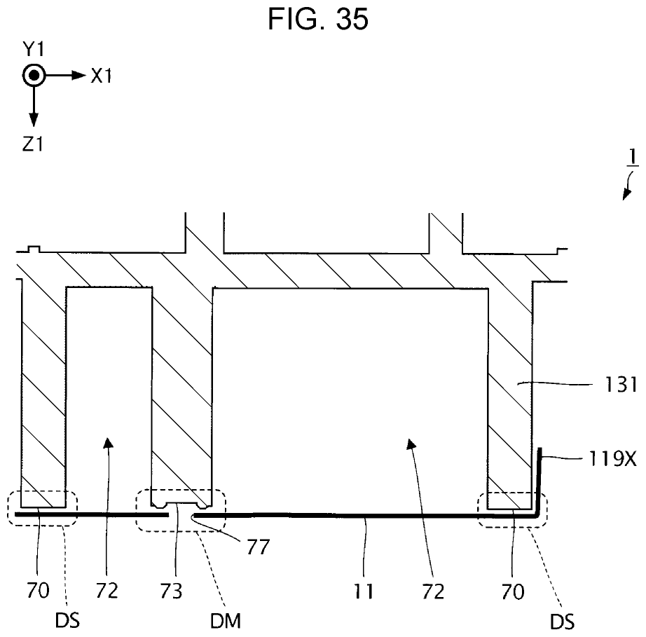

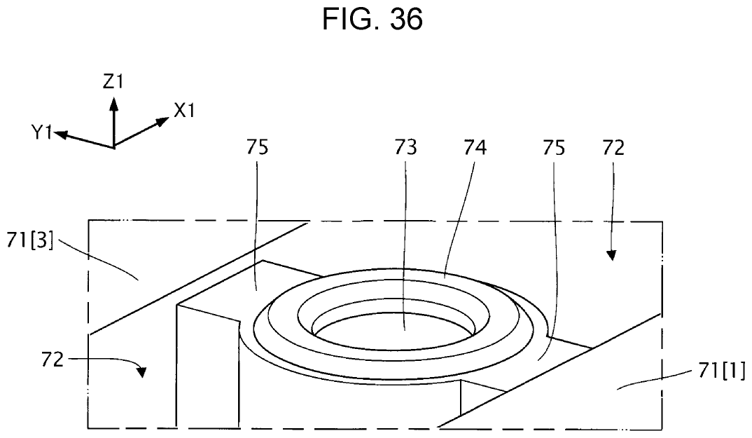

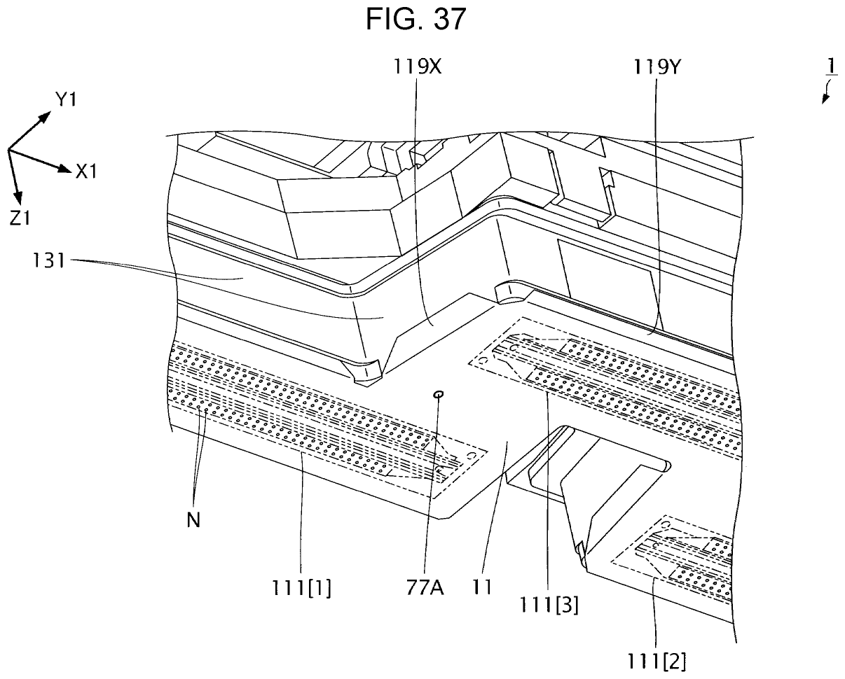

FIG. 32 is a plan view of the liquid ejecting head 1 including the lower holder 131, viewed in the Z2 direction in a state where the fixing plate 11 is removed from the liquid ejecting head 1. In FIG. 32, for convenience of explanation, the nozzle exposure openings 111 provided in the fixing plate 11 are illustrated on the holder 13. FIG. 33 is a cross-sectional view of the liquid ejecting head 1 taken along a plane having a normal direction parallel to the X-axis direction so as to include a fixing plate opening 77. FIG. 34 is an enlarged sectional view of the vicinity of the fixing plate opening 77 in FIG. 33. FIG. 35 is a cross-sectional view of the liquid ejecting head 1 taken along a plane having a normal direction parallel to the Y-axis direction so as to include the fixing plate opening 77. FIG. 36 is a perspective view of the lower holder 131. FIG. 37 is a perspective view of the liquid ejecting head 1 including the fixing plate 11 and the lower holder 131.

As illustrated in FIGS. 32 to 36, the lower holder 131 includes a peripheral wall portion 70. Here, the peripheral wall portion 70 is a portion of the lower holder 131 that includes the bottom surface of the housing portion 131S that houses the head chips 12. The peripheral wall portion 70 is provided so as to surround each of the four head chips 12[1] to 12[4] provided in the liquid ejecting head 1.

As illustrated in FIGS. 32 to 36, the peripheral wall portion 70 includes four partition wall portions 71 corresponding to the four head chips 12[1] to 12[4]. Here, the partition wall portions 71 are portions of the peripheral wall portion 70 provided between two head chips 12 adjacent to each other in the Y-axis direction.

Hereinafter, of the four partition wall portions 71 included in the peripheral wall portion 70, the partition wall portion 71 closest to the head chip 12[j] is referred to as the partition wall portion 71[j]. FIGS. 33 and 34 illustrate two partition wall portions 71 provided between the head chip 12[1] and the head chip 12[3], of the four partition wall portions 71 included in the peripheral wall portion 70. That is, FIGS. 33 and 34 illustrate the partition wall portion 71[1] closest to the head chip 12[1] and the partition wall portion 71[3] closest to the head chip 12[3], of the four partition wall portions 71 included in the peripheral wall portion 70.

As illustrated in FIGS. 32, 35, and 36, the peripheral wall portion 70 includes cutouts 72. The cutout 72 is a recessed portion provided inside the two partition wall portions 71 provided between two head chips 12 adjacent to each other in the Y-axis direction in the peripheral wall portion 70, and is a recessed portion provided so as to be recessed upward from the bottom surface of the peripheral wall portion 70. Hereinafter, as illustrated in FIG. 32, the cutout 72 provided between the partition wall portion 71[1] and the partition wall portion 71[3] may be referred to as the cutout 72A, and the cutout 72 provided between the partition wall portion 71[2] and the partition wall portion 71[4] may be referred to as the cutout 72B.

As illustrated in FIGS. 33 and 34, the bottom surface of the peripheral wall portion 70 and the fixing plate 11 function as bonding regions DS. Here, the bonding regions DS are regions including the bottom surface of the peripheral wall portion 70 and are regions which receive an adhesive DX1 and are fixed to the fixing plate 11. In addition, the bonding regions DS include four individual bonding regions DSS[1] to DSS[4] corresponding to the four partition wall portions 71[1] to 71[4]. The individual bonding region DSS[j] is a region which includes the bottom surface of the peripheral wall portion 70 and a region corresponding to the bottom surface of the partition wall portion 71[j] in a region which receives the adhesive DX1 and is fixed to the fixing plate 11.

As illustrated in FIGS. 32 to 36, a recessed portion 73 is provided in the bottom surface of the peripheral wall portion 70. The recessed portion 73 is a portion recessed in the Z2 direction in the bottom surface of the peripheral wall portion 70, is provided between two partition wall portions 71 adjacent to each other in the Y-axis direction, and is surrounded by the protruding portion 74 composing the end portion of the lower holder 131 in the Z1 direction. Hereinafter, as illustrated in FIG. 32, the recessed portion 73 provided between the partition wall portion 71[1] and the partition wall portion 71[3] may be referred to as the recessed portion 73A, and the recessed portion 73 provided between the partition wall portion 71[2] and the partition wall portion 71[4] may be referred to as the recessed portion 73B. In the present embodiment, it is assumed that the distance from the fixing plate 11 to the recessed portion 73 in the Z-axis direction is smaller than the diameter of the recessed portion 73 in a plan view in the Z2 direction. However, the distance from the fixing plate 11 to the recessed portion 73 in the Z-axis direction may be larger than the diameter of the recessed portion 73 in a plan view in the Z2 direction.

As illustrated in FIGS. 33 and 34, the recessed portion 73 and the fixing plate 11 function as a mold region DM. Here, the mold region DM is a region including the recessed portion 73 and is a region which receives an adhesive DX2 and is fixed to the fixing plate 11. In the present embodiment, the lower holder 131 and the fixing plate 11 are provided such that the fixing plate opening 77A and the recessed portion 73A are aligned with each other, and the fixing plate opening 77B and the recessed portion 73B are aligned with each other, in a plan view of the liquid ejecting head 1 in the Z2 direction. In the present embodiment, the recessed portion 73 is filled with the adhesive DX2 applied to the mold region DM, and the fixing plate opening 77 is closed. In the present embodiment, it is assumed that the recessed portion 73 is larger than the fixing plate opening 77 in a plan view in the Z1 direction.

In the present embodiment, as illustrated in FIG. 34, the mold region DM is arranged inside two individual bonding regions DSS adjacent to each other in the Y-axis direction so as to be spaced apart from the individual bonding regions DSS. Specifically, as illustrated in FIGS. 34 and 36, an outer peripheral clearance groove 75 is disposed on the bottom surface of the peripheral wall portion 70 between the partition wall portions 71 and the recessed portion 73. Therefore, in the present embodiment, it is possible to prevent the adhesive DX1 applied to the individual bonding regions DSS and the adhesive DX2 applied to the mold region DM from being mixed. Therefore, in the present embodiment, it is possible to employ different types of adhesive for the adhesive DX1 and the adhesive DX2, and the freedom of selection of the adhesive is increased.

In the present embodiment, it is assumed that different types of adhesive are used for the adhesive DX1 and the adhesive DX2. However, the same type of adhesive may be employed for the adhesive DX1 and the adhesive DX2.

Further, in the present embodiment, it is assumed that the distance from the fixing plate 11 to the recessed portion 73 in the Z-axis direction is longer than the distance from the fixing plate 11 to the outer peripheral clearance groove 75 in the Z-axis direction. However, the distance from the fixing plate 11 to the recessed portion 73 in the Z-axis direction may be equal to or less than the distance from the fixing plate 11 to the outer peripheral clearance groove 75 in the Z-axis direction.

Further, in the present embodiment, the mold region DM is arranged inside two individual bonding regions DSS adjacent to each other in the Y-axis direction so as to be spaced apart from the individual bonding regions DSS. Therefore, in the present embodiment, for example, it is possible to prevent the occurrence of a situation in which the amount of the adhesive in an individual bonding region DSS becomes excessive due to the adhesive DX2 applied to the mold region DM spreading to the individual bonding region DSS. Therefore, according to the present embodiment, it is possible to prevent the adhesion failure between the partition wall portion 71 and the fixing plate 11 in the individual bonding regions DSS.

As illustrated in FIG. 33, FIG. 35, and FIG. 37, in the present embodiment, the fixing plate 11 is provided with flat plate-shaped bent portions 119Y which are portions bent in the Z2 direction at end portions in the Y-axis direction and which have normal directions parallel to the Y-axis direction, and flat plate-shaped bent portions 119X which are portions bent in the Z2 direction at end portions in the X-axis direction and which have normal directions parallel to the X-axis direction. In the present embodiment, it is assumed that the widths of the bent portions 119X in the Z-axis direction are larger than the widths of the bent portions 119Y in the Z-axis direction. For this reason, in the present embodiment, when the wiper provided in the cleaning unit 94 moves in the X-axis direction, it is possible to reduce the possibility that the wiper comes into contact with the lower holder 131.

### B. Modifications

Each of the above-described configurations can be variously modified. Specific modified configurations will be described as examples below. Any two or more configurations selected from the following examples can be appropriately combined within a range in which the two or more configurations do not contradict each other.

### Modification 1

In the embodiment described above, a line head has been described as an example of the head unit HD, but the present disclosure is not limited to such a configuration. The head unit HD may be a serial head that ejects ink while reciprocating in the X-axis direction.

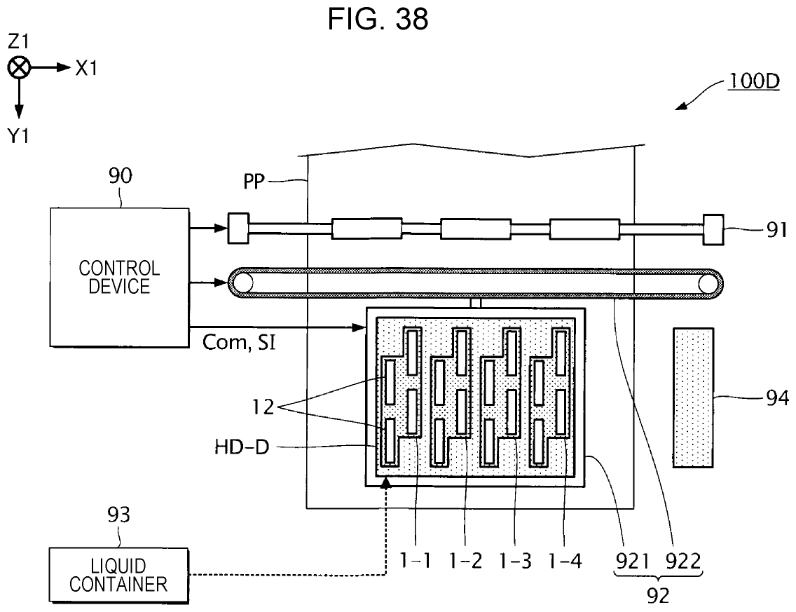

FIG. 38 is an explanatory diagram illustrating a liquid ejecting apparatus 100D according to Modification 1.

As illustrated in FIG. 38, the liquid ejecting apparatus 100D is different from the liquid ejecting apparatus 100 according to the embodiment in that the liquid ejecting apparatus 100D includes a head unit HD-D which is a serial head, instead of the head unit HD which is a line head, and in that the liquid ejecting apparatus 100D includes a movement mechanism 92 which reciprocates the head unit HD-D in the X1 direction and the X2 direction.

The movement mechanism 92 reciprocates the head unit HD-D in the X1 direction and the X2 direction under the control of the control device 90. The movement mechanism 92 includes a housing case 921 that houses the head unit HD-D, and an endless belt 922 to which the housing case 921 is fixed. The liquid container 93 may be housed in the housing case 921 together with the head unit HD-D.

The head unit HD-D is different from the head unit HD according to the embodiment in that the head unit HD-D includes a total of four liquid ejecting heads 1, namely, a liquid ejecting head 1-3 and a liquid ejecting head 1-4 in addition to a liquid ejecting head 1-1 and a liquid ejecting head 1-2 and in that each liquid ejecting head 1 is disposed in the head unit HD-D such that the head chips 12 provided in each liquid ejecting head 1 extend in the Y-axis direction.

In this modification, the variable m is a natural number that satisfies 1≤m≤4. In this modification, the m-th liquid ejecting head 1 of the liquid ejecting heads 1-1 to 1-4 is referred to as the liquid ejecting head 1-m.

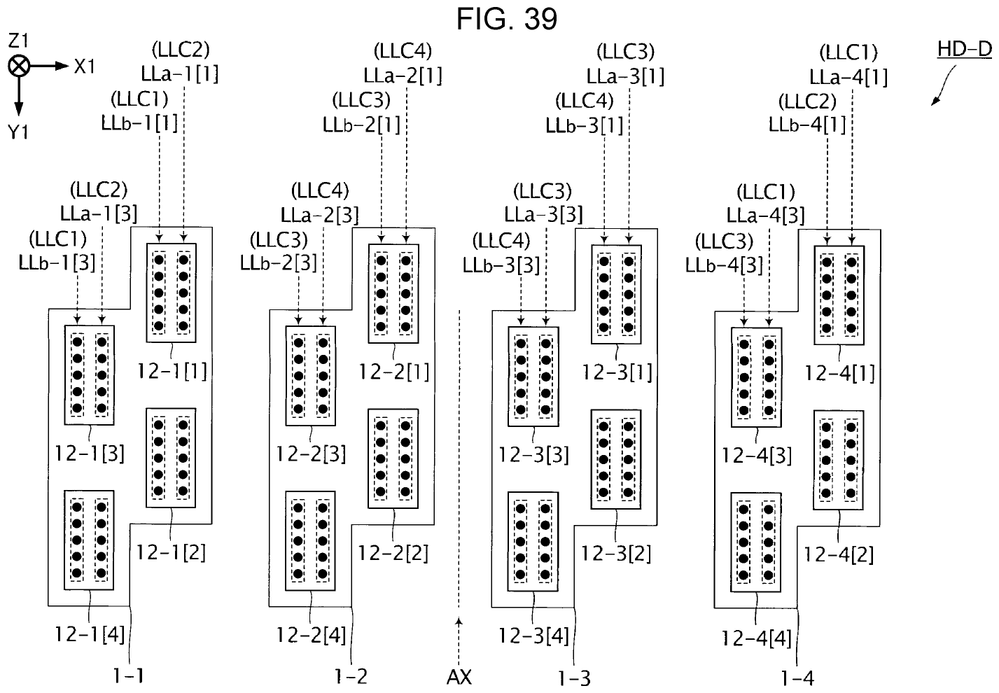

FIG. 39 is an explanatory diagram for explaining the arrangement of nozzle rows LL in the head unit HD-D.

As illustrated in FIG. 39, in the head unit HD-D, the liquid ejecting head 1-2 is provided in a region positioned in the X1 direction when viewed from the liquid ejecting head 1-1, the liquid ejecting head 1-3 is provided in a region positioned in the X1 direction when viewed from the liquid ejecting head 1-2, and the liquid ejecting head 1-4 is provided in a region positioned in the X1 direction when viewed from the liquid ejecting head 1-3.

In addition, in the present modification, similarly to the embodiment, four head chips 12 are provided for each liquid ejecting head 1-m. Hereinafter, of the four head chips 12 provided in the liquid ejecting head 1-m, the j-th head chip 12 is referred to as the head chip 12-m[j].

The head chip 12 according to the present modification has the same or a similar configuration as the head chip 12 according to the embodiment. In the present modification, in the liquid ejecting head 1-m, a head chip 12-m[2] is provided in a region positioned in the Y1 direction when viewed from a head chip 12-m[1], a head chip 12-m[3] is provided in a region positioned in a direction between the X2 direction and the Y1 direction when viewed from the head chip 12-m[1], and a head chip 12-m[4] is provided in a region positioned in the Y1 direction when viewed from the head chip 12-m[3].

Hereinafter, the two nozzle rows LL of the head chip 12-m[j] provided in the liquid ejecting head 1-m are referred to as the nozzle row LLa-m[j] and a nozzle row LLb-m[j]. The nozzle row LLa-m[j] is provided in a region positioned in the X1 direction when viewed from the nozzle row LLb-m[j].

In addition, in the present modification, of the four supply flow paths Q(1) to Q(4) included in the liquid ejecting head 1-m, ink of the same color is supplied to the supply flow path Q(1) and the supply flow path Q(3), and ink of the same color which is different from the ink supplied to the supply flow path Q(1) and the supply flow path Q(3) is supplied to the supply flow path Q(2) and the supply flow path Q(4). In the present modification, the color of ink ejected from each nozzle row LL is determined such that the colors of ink ejected from the 16 nozzle rows LL arranged in the X-axis direction in the head unit HD-D are line-symmetric with respect to an imaginary line AX extending in the Y-axis direction between the liquid ejecting head 1-2 and the liquid ejecting head 1-3.

Hereinafter, the nozzle rows LL that eject black ink are referred to as the black ejection nozzle rows LLC1. The nozzle rows LL that eject cyan ink are referred to as the cyan ejection nozzle rows LLC2. The nozzle rows LL that eject yellow ink are referred to as the yellow ejection nozzle rows LLC3. The nozzle rows LL that eject magenta ink are referred to as the magenta ejection nozzle rows LLC4.

In the present modification, black ink is supplied to the nozzle row LLb-1[1], the nozzle row LLb-1[2], the nozzle row LLb-1[3], and the nozzle row LLb-1[4], and the nozzle row LLa-4[1], the nozzle row LLa-4[2], the nozzle row LLa-4[3], and the nozzle row LLa-4[4], which function as the black ejection nozzle rows LLC1.

In the present modification, cyan ink is supplied to the nozzle row LLa-1[1], the nozzle row LLa-1[2], the nozzle row LLa-1[3], and the nozzle row LLa-1[4], and the nozzle row LLb-4[1], the nozzle row LLb-4[2], the nozzle row LLb-4[3], and the nozzle row LLb-4[4], which function as the cyan ejection nozzle rows LLC2.

In the present modification, yellow ink is supplied to the nozzle row LLb-2[1], the nozzle row LLb-2[2], the nozzle row LLb-2[3], and the nozzle row LLb-2[4], and the nozzle row LLa-3[1], the nozzle row LLa-3[2], the nozzle row LLa-3[3], and the nozzle row LLa-3[4], which function as the yellow ejection nozzle rows LLC3.

In the present modification, magenta ink is supplied to the nozzle row LLa-2[1], the nozzle row LLa-2[2], the nozzle row LLa-2[3], and the nozzle row LLa-2[4], and the nozzle row LLb-3[1], the nozzle row LLb-3[2], the nozzle row LLb-3[3], and the nozzle row LLb-3[4], which function as the magenta ejection nozzle rows LLC4.

According to the present modification, since the colors of ink ejected from the 16 nozzle rows LL arranged in the X-axis direction in the head unit HD-D are line-symmetric with respect to the imaginary line AX, the order of the colors of ink that lands on the medium PP when the head unit HD-D moves in the X1 direction can be the same as the order of the colors of ink that lands on the medium PP when the head unit HD-D moves in the X2 direction. For this reason, according to the present modification, it is possible to prevent the occurrence of unevenness or the like in the image formed on the medium PP and to form a higher-quality image, compared with configurations in which the colors of ink ejected from the 16 nozzle rows LL arranged in the X-axis direction in the head unit HD-D are not line-symmetric.

### Modification 2

The liquid ejecting apparatuses exemplified in the above-described embodiment and Modification 1 can be employed in various apparatuses such as a facsimile apparatus and a copy machine in addition to apparatuses dedicated to printing. However, the application of the liquid ejecting apparatus of the present disclosure is not limited to printing. For example, a liquid ejecting apparatus that ejects a solution of a coloring material is used as a manufacturing apparatus that forms a color filter of a liquid crystal display device. In addition, a liquid ejecting apparatus that ejects a solution of a conductive material is used as a manufacturing apparatus that forms wiring and electrodes of a wiring substrate.

### C. Appendices

Configurations related to the above description are appended below. In order to facilitate understanding of each configuration, in the following, reference signs in the drawings are given in parentheses for convenience, but it is not intended that the present disclosure is limited to the illustrated configurations.

### C.1. Appendix 1 Hereinafter, a liquid ejecting apparatus 100 and a liquid ejecting head 1 according to Appendix 1 will be described.

### Appendix 1-1

A liquid ejecting head 1 according to Appendix 1-1 includes: a nozzle row LLa[1] (an example of a “first nozzle group”) that ejects ink (an example of “liquid”); a nozzle row LLa[2] (an example of a “second nozzle group”) that ejects ink; and a holder 13 (an example of a plurality of flow path plates) including a lower holder 131, an intermediate holder 132, and an upper holder 133 which are stacked in a Z1 direction (an example of a “first direction”), the holder 13 includes a supply flow path Q for supplying ink to the nozzle row LLa[1] and the nozzle row LLa[2], and the supply flow path Q includes an extension flow path QR1 (an example of a “first flow path”) extending in the Z1 direction, an individual flow path QK1 (an example of a “first individual flow path”) connected to an end portion of the extension flow path QR1 in the Z1 direction, extending in an X2 direction intersecting the Z1 direction, and individually communicating with the nozzle row LLa[1], and an individual flow path QK2 (an example of a “second individual flow path”) connected to the extension flow path QR1 at a branch position GB located at an intermediate position on the extension flow path QR1, extending in an X1 direction intersecting the Z1 direction, and individually communicating with the nozzle row LLa[2].

According to Appendix 1-1, both the upstream portion of the extension flow path QR1 with respect to the branch position GB and the downstream portion of the extension flow path QR1 with respect to the branch position GB extend in the Z1 direction. For this reason, it is possible to effectively discharge ink positioned upstream of the branch position GB from the nozzle row LLa[1] by performing a suction cleaning process of sucking ink from the nozzle row LLa[1]. For this reason, according to Appendix 1-1, it is possible to effectively discharge air bubbles retained upstream of the branch position GB.

### Appendix 1-2

A liquid ejecting head 1 according to Appendix 1-2 is the liquid ejecting head 1 according to Appendix 1-1, in which the extension flow path QR1 is a flow path extending through the upper holder 133 and the intermediate holder 132 of the holder 13 in the Z1 direction, the individual flow path QK1 is a flow path defined between the lower holder 131 and the intermediate holder 132 adjacent to each other in the Z1 direction, and the individual flow path QK2 is a flow path defined between the intermediate holder 132 and the upper holder 133 adjacent to each other in the Z1 direction.

### Appendix 1-3

A liquid ejecting head 1 according to Appendix 1-3 is the liquid ejecting head 1 according to Appendix 1-1 or 1-2, in which the supply flow path Q includes a distribution flow path Q1 (an example of a “first distribution flow path”) including a distribution flow path QK1 and located downstream of the branch position GB, and includes a distribution flow path Q2 (an example of a “second distribution flow path”) including a distribution flow path QK2 and located downstream of the branch position GB, the distribution flow path Q2 includes an extension flow path QR2 (an example of a “second flow path”) defined between the lower holder 131 and the intermediate holder 132, and the lower holder 131 has a cutout portion KK disposed between the individual flow path QK1 and the extension flow path QR2 and disposed so as to overlap the individual flow path QK2 as viewed in the Z1 direction.

According to Appendix 1-3, since a medium pressing mechanism GZ can be disposed in the cutout portion KK, it is possible to reduce the size of the liquid ejecting apparatus 100 including the liquid ejecting head 1, compared with configurations without the cutout portion KK.

### Appendix 1-4

A liquid ejecting head 1 according to Appendix 1-4 is the liquid ejecting head 1 according to any one of Appendices 1-1 to 1-3, in which the flow path length of the individual flow path QK2 is shorter than the flow path length of the individual flow path QK1 and is shorter than the flow path length of the extension flow path QR2.

According to Appendix 1-4, it is possible to reduce the size of the upper holder 133, compared with cases where the flow path length of the individual flow path QK2 is longer than the flow path length of the individual flow path QK1 or cases where the flow path length of the individual flow path QK2 is longer than the flow path length of the extension flow path QR2.

### Appendix 1-5

A liquid ejecting head 1 according to Appendix 1-5 is the liquid ejecting head 1 according to any one of Appendices 1-1 to 1-4, in which, when viewed in the Z1 direction, the area inside the outer periphery of the upper holder 133 is smaller than the area inside the outer periphery of the lower holder 131 and is smaller than the area inside the outer periphery of the intermediate holder 132.

According to Appendix 1-5, it is possible to reduce the size of the liquid ejecting head 1, as compared with cases where the area inside the outer periphery of the upper holder 133 is larger than the area inside the outer periphery of the lower holder 131 or the area inside the outer periphery of the intermediate holder 132.

### Appendix 1-6

A liquid ejecting head 1 according to Appendix 1-6 is the liquid ejecting head 1 according to any one of Appendices 1-1 to 1-5, in which the individual flow path QK2 extends linearly.

According to Appendix 1-6, it is possible to reduce the size of the upper holder 133, compared with configurations in which the individual flow path QK2 extends in a curved shape.

### Appendix 1-7

A liquid ejecting head 1 according to Appendix 1-7 is the liquid ejecting head 1 according to any one of Appendices 1-1 to 1-6, further including, instead of the individual flow path QK2, an individual flow path QK2-C1 having an inclined portion which is inclined in the Z1 direction as it extends downstream from the branch position GB.

According to Appendix 1-7, it is possible to reduce the flow path resistance when ink flows from the extension flow path QR1 to the individual flow path QK2-C1.

### Appendix 1-8

A liquid ejecting apparatus 100 according to Appendix 1-8 includes: the liquid ejecting head 1 according to any one of Appendices 1-1 to 1-7; a cap 941 which forms a closed space communicating with a plurality of nozzles N formed in an ejection surface MF between the cap 941 and the ejection surface MF when the ejection surface MF of the liquid ejecting head 1 is sealed; and a suction pump 942 (an example of a “depressurizing mechanism”) which depressurizes the closed space formed by the cap 941 and the ejection surface MF.

### Appendix 1-9

A liquid ejecting apparatus 100 according to Appendix 1-9 includes: the liquid ejecting head 1 according to Appendix 1-3; a transport mechanism 91 that transports a medium PP on which ink ejected from the liquid ejecting head 1 lands; and a medium pressing mechanism GZ (an example of a “restriction portion”) that is disposed in the cutout portion KK and prevents the medium PP being transported by the transport mechanism 91 from deviating from the transport path.

### C.2. Appendix 2

Hereinafter, a liquid ejecting apparatus 100 and a head unit HD according to Appendix 2 will be described.

### Appendix 2-1

A head unit HD according to Appendix 2-1 includes: a liquid ejecting head 1-1 (an example of a “first liquid ejecting head”) that ejects ink (an example of “liquid”) in a Z1 direction (an example of a “first direction”); and a support member 5 that supports the liquid ejecting head 1-1, the support member 5 includes a support plate 50 having a lower surface P511 (an example of a “first surface”) that supports the liquid ejecting head 1-1 and faces the Z1 direction, and a head positioning pin SP (an example of a “first positioning portion”) for positioning the liquid ejecting head 1-1 with respect to the support plate 50, the liquid ejecting head 1-1 includes a plurality of head chips 12 having a plurality of nozzle rows LL (an example of a “nozzle group”) that ejects ink, a fixing plate 11 (an example of a “cover member”) in which a plurality of nozzle exposure openings 111 (an example of an “exposure opening portion”) for exposing each of the plurality of nozzle rows LL to the outside are formed and to which the plurality of head chips 12 are fixed, a lower holder 131 (an example of a “base member”) to which the fixing plate 11 is fixed, and a multilayer structure 55 that includes a plurality of stacked substrates stacked in the Z1 direction and is stacked in a Z2 direction (an example of a “second direction”) opposite to the Z1 direction on a mounting surface PS13 provided on the lower holder 131, the multilayer structure 55 includes a facing portion BT that faces the lower surface P511, the lower holder 131 includes a protruding portion 131T protruding in the Z2 direction from the mounting surface PS13, and the protruding portion 131T includes a contact surface PT13 that is in contact with the lower surface P511 and a support-plate positioning hole AB (an example of a “second positioning portion) that is provided to correspond to the head positioning pin SP and that positions the liquid ejecting head 1-1 with respect to the support plate 50.

According to Appendix 2-1, for example, it is possible to increase the positioning accuracy of the head chips 12 with respect to the support plate 50, compared with configurations in which the support-plate positioning hole AB is provided in the multilayer structure 55.

### Appendix 2-2

A head unit HD according to Appendix 2-2 is the head unit HD according to Appendix 2-1, in which the area of the facing portion BT of the multilayer structure 55 is larger than the area of a non-facing portion BH of the multilayer structure 55 which does not overlap with the support plate 50, when viewed in Z1 direction.

According to Appendix 2-2, the area of the portion of the support plate 50 facing the multilayer structure 55 can be increased, compared with configurations in which the facing portion BT is smaller than the non-facing portion BH. Therefore, the stiffness of the support plate 50 can be increased.

### Appendix 2-3

A head unit HD according to Appendix 2-3 is the head unit HD according to Appendix 2-1 or 2-2, in which the support plate 50 is provided with a plurality of electrical connection openings AC and a plurality of connection flow path openings AR which extend through the support plate 50 in the Z1 direction, and each of the plurality of electrical connection openings AC and the plurality of connection flow path openings AR is smaller than an ejection surface MF of the liquid ejecting head 1-1 when viewed in the Z1 direction.

According to Appendix 2-3, it is possible to increase the stiffness of the support plate 50, compared with configurations in which an opening larger than the ejection surface MF is provided in the support plate 50.

### Appendix 2-4

A head unit HD according to Appendix 2-4 is the head unit HD according to any one of Appendices 2-1 to 2-3, in which the first positioning portion may be a positioning hole or a positioning blind hole having a bottom wall, and the second positioning portion may be a positioning pin inserted into the positioning hole or the positioning blind hole.

### Appendix 2-5

A head unit HD according to Appendix 2-5 is the head unit HD according to any one of Appendices 2-1 to 2-4, in which the lower holder 131 includes a housing portion 131S that overlaps the head chips 12 when viewed in a X1 direction (an example of a “third direction”) orthogonal to the Z1 direction.

### Appendix 2-6

A head unit HD according to Appendix 2-6 is the head unit HD according to any one of Appendices 2-1 to 2-5, further including a lower holder 131-B2 to which the plurality of head chips 12 are fixed, instead of the lower holder 131.

According to Appendix 2-6, it is possible to increase the positioning accuracy of the head chips 12 with respect to the support plate 50.

### Appendix 2-7

A head unit HD according to Appendix 2-7 is the head unit HD according to any one of Appendices 2-1 to 2-6, further including: a liquid ejecting head 1-2 (an example of a “second liquid ejecting head”) that is supported on the lower surface P511 of the support plate 50 and ejects liquid in the Z1 direction; a common flow path member 41 provided in the Z2 direction when viewed from the support plate 50 and connected to a flow path of the liquid ejecting head 1-1 and a flow path of the liquid ejecting head 1-2, in which the support plate 50 includes a plurality of connection flow path openings AR-1 through which connection flow paths RR-1 (an example of a “first flow path connection portion”) that connect the common flow path member 41 and the flow path of the liquid ejecting head 1-1 are inserted and a plurality of connection flow path openings AR-2 through which connecting flow paths RR-2 (an example of a “second flow path connection portion”) that connects the common flow path member 41 and the flow path of the liquid ejecting head 1-2 are inserted, and the area of each of the connection flow path openings AR-1 and the area of each of the connection flow path openings AR-2 are smaller than the area inside the outer periphery of the multilayer structure 55 when viewed in the Z1 direction.

According to Appendix 2-7, it is possible to increase the stiffness of the support plate 50, compared with configurations in which an opening larger than the outer periphery of the multilayer structure 55 is provided in the support plate 50.

### Appendix 2-8

A head unit HD according to Appendix 2-8 is the head unit HD according to any one of Appendices 2-1 to 2-7, further including: a liquid ejecting head 1-2 that is supported on the lower surface P511 of the support plate 50 and ejects liquid in the Z1 direction; and a common electrical member 42 provided in the Z2 direction when viewed from the support plate 50 and electrically connected to electronic components of the liquid ejecting head 1-1 and electronic components of the liquid ejecting head 1-2, in which the support plate 50 includes an electrical connection opening AC-1 through which a B-to-B connector CN-1 (an example of a “first electrical connection portion”) for electrically connecting the common electrical member 42 and the electronic components of the liquid ejecting head 1-1 is inserted and an electrical connection opening AC-2 through which a B-to-B connector CN-2 (an example of a “second electrical connection portion”) for electrically connecting the common electrical member 42 and the electronic components of the liquid ejecting head 1-2 is inserted, and the area of the electrical connection opening AC-1 and the area of the electrical connection opening AC-2 are smaller than the area inside the outer periphery of the multilayer structure 55 when viewed in the Z1 direction.

According to Appendix 2-8, it is possible to increase the stiffness of the support plate 50, compared with configurations in which an opening larger than the outer periphery of the multilayer structure 55 is provided in the support plate 50.

### Appendix 2-9

A head unit HD according to Appendix 2-9 is the head unit HD according to any one of Appendices 2-1 to 2-8, in which the multilayer structure 55 includes a filter unit 16 including a filter FF through which the ink flowing inside the liquid ejecting head 1-1 passes.

According to Appendix 2-9, it is possible to capture foreign matter and air bubbles included in the ink which is supplied to the liquid ejecting head 1-1, in advance.

### Appendix 2-10

A head unit HD according to Appendix 2-10 is the head unit HD according to any one of Appendices 2-1 to 2-9, in which the multilayer structure 55 includes the lower holder 131 and an intermediate holder 132 (an example of a “flow path plate”) for supplying ink to the plurality of head chips 12.

### Appendix 2-11

A head unit HD according to Appendix 2-11 is the head unit HD according to any one of Appendices 2-1 to 2-10, in which the multilayer structure 55 includes a relay substrate 14 electrically connected to the plurality of head chips 12.

### Appendix 2-12

A head unit HD according to Appendix 2-12 is the head unit HD according to any one of Appendices 2-1 to 2-11, in which the lower holder 131 includes a housing portion 131S that is located in the Z1 direction with respect to the mounting surface PS13 and houses the head chips 12, and an end portion of the housing portion 131S in an X1 direction orthogonal to the Z1 direction is located between an end portion of the head chips 12 in the X1 direction and an end portion of the protruding portion 131T in the X1 direction.

According to Appendix 2-12, since the protruding portion 131T has a structure protruding outward from the housing portion 131S, it is easy to secure a space for housing the multilayer structure 55.

### Appendix 2-13

A head unit HD-B1 according to Appendix 2-13 includes: a liquid ejecting head 1-1 that ejects ink in a Z1 direction; and a support member 5 that supports the liquid ejecting head 1-1, the support member 5 includes a support plate 50 having a lower surface P511 that supports the liquid ejecting head 1-1 and faces the Z1 direction, and a head positioning pin SP for positioning the liquid ejecting head 1-1 with respect to the support plate 50, the liquid ejecting head 1-1 includes a plurality of head chips 12 having a plurality of nozzle rows LL for ejecting ink, a lower holder 131-B2 (an example of a “fixing member”) to which the plurality of head chips 12 are fixed, and a multilayer structure 55 that includes a plurality of stacked substrates stacked in the Z1 direction and is stacked in a Z2 direction opposite to the Z1 direction on a mounting surface PS13 provided on the lower holder 131-B2, the multilayer structure 55 includes a facing portion BT that faces the lower surface P511, the lower holder 131-B2 includes a protruding portion 131T protruding from the mounting surface PS13 in the Z2 direction, the protruding portion 131T includes a contact surface PT13 in contact with the lower surface P511 and a support-plate positioning hole AB that is provided to correspond to the head positioning pin SP and positions the liquid ejecting head 1-1 with respect to the support plate 50.

### Appendix 2-14

A liquid ejecting apparatus 100 according to Appendix 2-14 includes: the head unit HD (which may be the head unit HD-B1 or the head unit HD-B2) according to any one of Appendices 2-1 to 2-13; and a main body frame 900 that supports the head unit HD, and the support member 5 includes a frame positioning hole AQ (an example of a “third positioning portion”) that is disposed in a flat plate portion 51 provided with the lower surface P511 of the support plate 50 and positions the support member 5 with respect to the main body frame 900, and a frame fixing screw hole AM (an example of a “fixing portion”) that is disposed in the flat plate portion 51 and fixes the support plate 50 to the main body frame 900.

According to Appendix 2-14, since the frame positioning hole AQ is provided on the same plane as the head positioning hole AP, the positioning accuracy of the liquid ejecting head 1 with respect to the main body frame 900 is improved, compared with configurations in which the head positioning hole AP and the frame positioning hole AQ are provided on different planes.

### C.3. Appendix 3

Hereinafter, a liquid ejecting head 1 according to Appendix 3 will be described.

### Appendix 3-1

A liquid ejecting head 1 according to Appendix 3-1 includes: a filter fixing screw 61 (an example of a “screw”) that is inserted into a filter fixing screw hole 63 (an example of a “fixing hole”) extending through a substrate cover 15 (an example of a “first component”) and a filter unit 16 (an example of a “second component”) in a Z1 direction (an example of a “first direction”) and fastens the substrate cover 15 and the filter unit 16; and a metal nut 62 that is inserted in an X1 direction (an example of a “second direction”) intersecting the Z1 direction into a housing portion 64 provided in the substrate cover 15 so as to extend in the X1 direction and that is coupled to the filter fixing screw 61.

According to Appendix 3-1, since the Z1 direction which is the insertion direction of the filter fixing screw 61 into the nut 62 and the X1 direction which is the insertion direction of the nut 62 into the housing portion 64 are directions that intersect each other, it is possible to prevent the nut 62 from falling off from the housing portion 64 when the filter fixing screw 61 is coupled to the nut 62.

### Appendix 3-2

A liquid ejecting head 1 according to Appendix 3-2 is the liquid ejecting head 1 according to Appendix 3-1, in which the nut 62 is press-fitted into the housing portion 64.

According to Appendix 3-2, when the filter fixing screw 61 is coupled to the nut 62, it is possible to prevent the nut 62 from falling off from the housing portion 64.

### Appendix 3-3

A liquid ejecting head 1 according to Appendix 3-3 is the liquid ejecting head 1 according to Appendix 3-1 or 3-2, in which the housing portion 64 has an inner end surface 641 (an example of a “first surface”) that defines an end portion of the housing portion 64 in the X1 direction, and a screw hole 621 provided in the nut 62 and the filter fixing screw hole 63 are aligned with each other when viewed in the Z1 direction in a state where the nut 62 is in contact with the inner end surface 641.

According to Appendix 3-3, it is easy to guide the nut 62 to be positioned in the X1 direction.

### Appendix 3-4

A liquid ejecting head 1 according to Appendix 3-4 is the liquid ejecting head 1 according to any one of Appendices 3-1 to 3-3, in which the housing portion 64 has a position defining surface 642 (an example of a “second surface”) for defining the position in the Z1 direction of the nut 62 housed in the housing portion 64.

According to Appendix 3-4, it is possible to prevent the position of the nut 62 from shifting in the Z1 direction.

### Appendix 3-5

A liquid ejecting head 1 according to Appendix 3-5 is the liquid ejecting head 1 according to any one of Appendices 3-1 to 3-4, in which the housing portion 64 has an inner end surface 641 that defines an end portion of the housing portion 64 in the X1 direction, and the inner end surface 641 is provided with a nut push-out opening 65 (an example of an “opening”) communicating with the outside of the housing portion 64.

According to Appendix 3-5, by pushing the nut 62 with a rod or the like through the nut push-out opening 65, the nut 62 can be easily taken out from the housing portion 64.

### Appendix 3-6

A liquid ejecting head 1 according to Appendix 3-6 is the liquid ejecting head 1 according to any one of Appendices 3-1 to 3-5, in which the nut 62 is provided with a screw groove 622 extending in the X1 direction.

According to Appendix 3-6, the nut 62 is easily taken out from the housing portion 64 by fastening a screw to the screw groove 622 and pulling the screw in the X2 direction.

### Appendix 3-7

A liquid ejecting head 1 according to Appendix 3-7 is the liquid ejecting head 1 according to any one of Appendices 3-1 to 3-6, in which a gap 644 extending in the X1 direction and communicating with the screw hole 621 of the nut 62 housed in the housing portion 64 is provided in a wall surface of the housing portion 64.

According to Appendix 3-7, by inserting the distal end portion of an L-shaped rod into the screw hole 621 and pulling the rod in the X2 direction, the nut 62 can be easily taken out from the housing portion 64.

### Appendix 3-8

A liquid ejecting apparatus 100 according to Appendix 3-8 includes: the liquid ejecting head 1 according to any one of Appendices 3-1 to 3-7; and a liquid container 93 that stores ink to be supplied to the liquid ejecting head 1.

### C.4. Appendix 4

Hereinafter, a liquid ejecting head 1 according to Appendix 4 will be described.

### Appendix 4-1

A liquid ejecting head 1 according to Appendix 4-1 includes: a plurality of head chips 12 that eject ink (an example of “liquid”); a fixing plate 11 to which the plurality of head chips 12 are fixed; and a lower holder 131 (an example of a “holder”) that holds the plurality of head chips 12 between the lower holder 131 and the fixing plate 11, each of the head chips 12 includes a nozzle row LL (an example of a “nozzle group”) that ejects ink, the fixing plate 11 includes a plurality of nozzle exposure openings 111 (an example of “exposure opening portions”) provided to correspond to the plurality of nozzle rows LL so as to expose each of the nozzle rows LL corresponding to the plurality of head chips 12 to the outside, and includes a fixing plate opening 77 (an example of a “hole portion”) different from the plurality of nozzle exposure openings 111, the lower holder 131 includes a peripheral wall portion 70 surrounding each of the plurality of head chips 12 in a plan view in the Z2 direction, and includes a cutout 72 provided inside a partition wall portion 71 disposed between two head chips 12 adjacent to each other in the peripheral wall portion 70, a bottom surface of the lower holder 131 includes a bonding region DS overlapping the peripheral wall portion 70 in a plan view in the Z2 direction and attached to the fixing plate 11 with an adhesive, and includes a recessed portion 73 disposed inside an individual bonding region DSS of the bonding region DS overlapping the partition wall portion 71 in a plan view in the Z2 direction, the fixing plate opening 77 is disposed inside the cutout 72 in a plan view in the Z2 direction, and the recessed portion 73 is aligned with the fixing plate opening 77 in a plan view in the Z2 direction and is disposed inside the individual bonding region DSS to be spaced apart from the individual bonding region DSS.

According to Appendix 4-1, since the individual bonding region DSS and the recessed portion 73 are disposed to be spaced apart from each other, it is possible to prevent mixing of an adhesive DX1 applied to the individual bonding region DSS and an adhesive DX2 applied to close the fixing plate opening 77. Therefore, according to Appendix 4-1, it is possible to prevent an adhesion failure between the lower holder 131 and the fixing plate 11.

### Appendix 4-2

A liquid ejecting head 1 according to Appendix 4-2 is the liquid ejecting head 1 according to Appendix 4-1, in which the recessed portion 73 is filled with an adhesive DX2.

### Appendix 4-3

A liquid ejecting head 1 according to Appendix 4-3 is the liquid ejecting head 1 according to Appendix 4-1 or 4-2, in which the adhesive DX2 that fills the recessed portion 73 and an adhesive DX1 used for bonding the fixing plate 11 and the lower holder 131 together in the individual bonding region DSS are arranged to be spaced apart from each other.

### Appendix 4-4

A liquid ejecting head 1 according to Appendix 4-4 is the liquid ejecting head 1 according to any one of Appendices 4-1 to 4-3, in which the size of the recessed portion 73 is larger than the size of the fixing plate opening 77 in a plan view in the Z2 direction.

### Appendix 4-5

A liquid ejecting head 1 according to Appendix 4-5 is the liquid ejecting head 1 according to any one of Appendices 4-1 to 4-4, in which the bottom surface of the lower holder 131 includes an outer peripheral clearance groove 75 disposed on the outer periphery of the recessed portion 73, and the distance from the fixing plate 11 to the bottom surface of the recessed portion 73 is longer than the distance from the fixing plate 11 to a bottom surface of the outer peripheral clearance groove 75.

### Appendix 4-6

A liquid ejecting head 1 according to Appendix 4-6 is the liquid ejecting head 1 according to any one of Appendices 4-1 to 4-5, in which the distance from the fixing plate 11 to the bottom surface of the recessed portion 73 is smaller than the diameter of the recessed portion 73 in a plan view of the recessed portion 73.

What is claimed is:

1. A liquid ejecting head comprising:
a first nozzle group configured to eject liquid;
a second nozzle group configured to eject liquid; and
a plurality of flow path plates stacked in a first direction, wherein
the plurality of flow path plates include
a supply flow path for supplying liquid to the first nozzle group and the second nozzle group, and
the supply flow path includes
a first flow path extending in the first direction,
a first individual flow path connected to an end portion of the first flow path in the first direction, extending in a direction intersecting the first direction, and individually communicating with the first nozzle group, and
a second individual flow path connected to the first flow path at a branch position located at an intermediate position on the first flow path, extending in a direction intersecting the first direction, and individually communicating with the second nozzle group.

2. The liquid ejecting head according to claim 1, wherein
the first flow path is a flow path extending through at least two flow path plates of the plurality of flow path plates in the first direction,
the first individual flow path is a flow path defined between a first flow path plate and a second flow path plate adjacent to each other in the first direction among the plurality of flow path plates, and
the second individual flow path is a flow path defined between the second flow path plate and a third flow path plate adjacent to each other in the first direction among the plurality of flow path plates.

3. The liquid ejecting head according to claim 2, wherein
the supply flow path includes
a first distribution flow path including the first individual flow path and located downstream of the branch position, and
a second distribution flow path including the second individual flow path and located downstream of the branch position,
the second distribution flow path includes
a second flow path defined between the first flow path plate and the second flow path plate, and
the first flow path plate includes
a cutout portion disposed between the first individual flow path and the second flow path and disposed so as to overlap the second individual flow path as viewed in the first direction.

4. The liquid ejecting head according to claim 3, wherein
a flow path length of the second individual flow path is shorter than a flow path length of the first individual flow path and is shorter than a flow path length of the second flow path.

5. The liquid ejecting head according to claim 4, wherein
when viewed in the first direction, an area inside an outer periphery of the third flow path plate is smaller than an area inside an outer periphery of the first flow path plate and is smaller than an area inside an outer periphery of the second flow path plate.

6. The liquid ejecting head according to claim 4, wherein
the second individual flow path extends linearly.

7. The liquid ejecting head according to claim 1, wherein
the second individual flow path includes an inclined portion that is inclined in the first direction as the inclined portion extends downstream from the branch position.

8. A liquid ejecting apparatus comprising:
the liquid ejecting head according to claim 1;
a cap configured to form a closed space communicating with a plurality of nozzles formed in an ejection surface, between the cap and the ejection surface, when the cap seals the ejection surface of the liquid ejecting head; and
a depressurizing mechanism that depressurizes the closed space.

9. A liquid ejecting apparatus comprising:
the liquid ejecting head according to claim 3;
a transport mechanism that transports a medium on which liquid ejected from the liquid ejecting head lands; and
a restriction portion that is disposed in the cutout portion and prevents the medium being transported along a transport path by the transport mechanism from deviating from the transport path.
